(19) United States
(12) Patent Application Publication
(10) Pub. No.: US 2024/0146757 A1
(43) Pub. Date: May 2, 2024

(54) ANALYSIS APPARATUS, ANALYSIS SYSTEM, ANALYSIS METHOD AND ANALYSIS PROGRAM

(71) Applicant: NEC Corporation, Minato-ku, Tokyo (JP)

(72) Inventors: Kazuhiko lsoyama, Tokyo (JP); Junpei Kamimura, Tokyo (JP); Yoshiaki Sakae, Tokyo (JP)

(73) Assignee: NEC Corporation, Minato-ku, Tokyo (JP)

(21) Appl. No.: 18/281,230

(22) PCT Filed: Mar. 19, 2021
(86) PCT No.: PCT/JP2021/011445

§ 371 Date: Sep. 8, 2023

(51) Int. Cl. H04L 9/40

(52) U.S. Cl. CPC H04L 63/1433; H04L 63/0209; H04L 63/20

(57) ABSTRACT

It is determined whether to involve the security risk based on the data flow in the system to be analyzed. An analysis apparatus 1A a historical information collecting unit 220A configured to collect historical information on an operational history for a program executed in a system to be analyzed, an information adding unit 230 configured to add to the historical information, external information obtained from an information resource other than an information processing apparatus that executes the program, and a risk determining unit 180A configured to perform a risk determining processing for determining based on preset determining condition, whether to involve security risk in the historical information to which the external information is added.

### TECHNICAL FIELD

The present invention relates to an analysis condition generating apparatus, an analysis system, an analysis condition generating program, an analysis program, an analysis condition generating method, and an analysis method.

### BACKGROUND ART

In recent years, it is preferred to enhance security in a system connected to a network, and service for analyzing security risk in the system is provided such as vulnerability assessment and penetration test.

The vulnerability assessment is a method for comprehensively understanding based on definition of known vulnerability such as a SQL injection and Cross-Site Request Forgeries, the vulnerability inherent in the system and lackness of a security function. The penetration test is a method for analyzing based on an attacking scenario prepared in advance, whether an attacking goal is achieved with attack to the system, and understanding possibility in damage to the system.

The vulnerability assessment can comprehensively verify entire the system, whereas it is difficult to understand undefined vulnerability. Also, the penetration test can verify a specific invasion manner to the system, whereas it involves a problem in which cost and time are increased when comprehensively analyzing the system. For the above-mentioned problem, a technique for analyzing the security risk is proposed focusing on treating data in the system.

For example, PTL 1 proposes a technique for determining validity for an operation of a device based on system call execution information on an OS executed by the device in a system to be analyzed. The system call is a scheme for a program to use a resource managed by the OA, and the system call execution information in PTL 1 includes a system call name and an argument. In the description of PTL 1, it is determined that the device that matches a fraudulent pattern and that corresponds to a system call execution history involves a problem in security.

Also, for example, PTL 2 discloses a technique for generating a data transport route based on program operational information in which an operational specification for a program is described, and for validating whether the data transport route violates security by determining whether to match a preset policy. In the description of PTL 2, a behavior of the program in a system to be analyzed is modeled as the data transport route, and it is determined whether the data transport route violates the security.

### CITATION LIST

### Patent Literature

[PTL 1] JP 2019-028670

[PTL 2] JP 2005-196728

### SUMMARY

### Technical Problem

The technique disclosed in PTL 1 can determine the validity for the operation of the device based on a processing performed by an application executed on the system. However, in the description of PTL 1, there is a problem in which the validity cannot be determined for treating the data in the system caused by a security issue not due to attack or failure.

Also, in the technique disclosed in PTL 2, the data transport route is generated based on the information in which the operational specification for the program is described. The “information in which the operational specification for the program is described” is security setting information and information including a type of node and arc created on the model, and is not information indicating the behavior of the program when actually executing the program. Therefore, if the data is exchanged in the data transport route not generated based on the “information in which the operational specification for the program is described”, there is an issue in which it cannot be validated whether to violate the security. On the other hand, in order to reduce defeat for the data transport route in analyzing the security risk, it is necessary to describe the operational specification for the program in detail. In this case, the problem cannot be solved in which cost and time required for analyzing the security risk are increased.

An object of the present invention is made for solving the above problem, and is to determine whether to involve security risk based on an actual data flow in a system to be analyzed.

### Solution to Problem

In order to solve the above problem, an analysis apparatus according to the present invention includes a historical information collecting unit configured to collect historical information on an operational history of a program executed in a system to be analyzed, an information adding unit configured to add to the historical information, external information obtained from an information resource other than an information processing apparatus that executes the program, and a risk determining unit configured to perform a risk determining processing for determining based on a preset determining condition, whether the historical information to which the external information is added involves security risk.

In order to solve the above problem, an analysis system according to the present invention includes an analysis apparatus including a historical information collecting unit configured to collect historical information on an operational history of a program executed in a system to be analyzed, an information adding unit configured to add to the historical information, external information obtained from an information resource other than an information processing apparatus that executes the program, and a risk determining unit configured to perform a risk determining processing for determining based on a preset determining condition, whether the historical information to which the external information is added involves security risk.

In order to solve the above problem, an analysis method according to the present invention includes collecting historical information on an operational history of a program executed in a system to be analyzed, adding to the historical information, external information obtained from an information resource other than an information processing apparatus that executes the program, and performing a risk determining processing for determining based on a preset determining condition, whether the historical information to which the external information is added involves security risk.

In order to solve the above problem, an analysis program according to the present invention causes a processor to collect historical information on an operational history of a program executed in a system to be analyzed, add to the historical information, external information obtained from an information resource other than an information processing apparatus that executes the program, and perform a risk determining processing for determining based on a preset determining condition, whether the historical information to which the external information is added involves security risk.

### Advantageous Effects of Invention

According to the present invention, it can be determined whether to involve the security risk based on the actual data flow in the system to be analyzed. It is noted that in addition to or alternative to the above effect, other effect may be provided according to the present invention.

### BRIEF DESCRIPTION OF THE DRAWINGS

FIG. 1 is a diagram illustrating an operational style of an analysis system according to a first example embodiment.

FIG. 2 is a model diagram for describing a data route for exchange in an authentication system according to the first example embodiment.

FIG. 3 is a block diagram showing a hardware configuration of an information processing apparatus according to the first example embodiment.

FIG. 4 is a functional block diagram showing a functional configuration of an analysis server according to the first example embodiment.

FIG. 5 is a sequence diagram showing a flow in a processing in the analysis system according to the first example embodiment.

FIG. 6A is a diagram illustrating a structure of a historical information data table according to the first example embodiment.

FIG. 6B is a diagram illustrating a structure of an access right information data table according to the first example embodiment.

FIG. 7 is a flowchart showing a flow in a data flow information generating processing in the analysis server according to the first example embodiment.

FIG. 8 is a diagram showing an example of data flow information according to the first example embodiment.

FIG. 9 is a flowchart showing a flow in a risk determining processing in the analysis server according to the first example embodiment.

FIG. 10 is a diagram showing an example of a GUI on which a determination result of the risk determining processing is displayed according to the first example embodiment.

FIG. 11 is a diagram describing the data route for exchange in a project management system according to the first example embodiment.

FIG. 12 is a diagram illustrating the operational style of the analysis system according to a second example embodiment.

FIG. 13 is a diagram showing an overview of the system to be analyzed according to the second example embodiment.

FIG. 14 is a functional block diagram showing the functional configuration of the analysis server according to the second example embodiment.

FIG. 15 is a sequence diagram showing the flow in the processing in the analysis system according to the second example embodiment.

FIG. 16 is a diagram describing a detail of a determining condition according to the second example embodiment.

FIG. 17 is a sequence diagram showing the flow in the risk determining processing according to the second example embodiment.

FIG. 18 is a diagram illustrating the analysis system according to a third example embodiment.

FIG. 19 is a diagram illustrating a configuration of the analysis apparatus according to the third example embodiment.

### DESCRIPTION OF THE EXAMPLE EMBODIMENTS

Hereinafter, example embodiments of the present invention are described in detail with reference to the accompanying drawings. Note that, in the Specification and drawings, elements to which similar descriptions are applicable are denoted by the same reference signs, and overlapping descriptions may hence be omitted.

Each example embodiment described below is merely an example of a configuration that can implement the present invention. Each example embodiment described below can be appropriately modified or changed according to a configuration of an apparatus to which the present invention is applied and various conditions. All of combinations of elements included in each example embodiment described below are not necessarily required to implement the present invention, and a part of the elements can be appropriately omitted. Hence, the scope of the present invention is not limited by configurations described in each example embodiment described below.

Configurations in which a plurality of configurations described in the example embodiments are combined can also be adopted unless the configurations are consistent with each other.

Descriptions according to the present invention will be given in the following order.
1. Overview of Example Embodiments of Present Invention
2. First Example Embodiment
   2.1. Operational Style of Analysis System
   2.2. Overview of Data Route for Exchange in Authentication System
   2.3. Configuration of Analysis Server
      2.3.1. Hardware Configuration of Information Processing Apparatus such as Analysis Server
      2.3.2. Functional Configuration of Analysis Server
   2.4. Overview of Processing in Analysis System
      2.4.1. Flow in Processing in Analysis System
      2.4.2. Flow in Data Flow Information Generating Processing in Analysis Server
      2.4.3. Flow in Risk Determining Processing in Analysis Server
      2.4.4. Treatment of Determination Result of Risk Determining Processing
3. Modification
4. Second Example Embodiment
   4.1. Operational Style of Analysis System
   4.2. Overview of System to be analyzed
   4.3. Functional Configuration of Analysis Server
   4.4. Overview of Processing in Analysis System
      4.4.1. Flow in Processing in Analysis System
      4.4.2. Flow in Risk Determining Processing in Analysis Server
5. Third Example Embodiment
6. Other Example Embodiment

### <<1. Overview of Example Embodiments of Present Invention>>

Firstly, an overview of example embodiments of the present invention is described

### (1) Technical Problem

In recent years, it is preferred to enhance security for a system connected to a network, and service for analyzing security risk in the system is provided such as vulnerability assessment and penetration test.

The vulnerability assessment is a method for comprehensively understanding based on definition of known vulnerability such as a SQL injection and Cross-Site Request Forgeries, the vulnerability inherent in the system and lackness of a security function. The penetration test is a method for analyzing based on an attacking scenario prepared in advance, whether an attacking goal is achieved with attack to the system, and understanding possibility in damage to the system.

The vulnerability assessment can comprehensively verify entire the system, whereas it is difficult to understand undefined vulnerability. Also, the penetration test can verify a specific invasion manner to the system, whereas it involves a problem in which cost and time are increased when comprehensively analyzing the system. For the above-mentioned problem, a technique for analyzing the security risk is proposed focusing on treating data in the system.

For example, a technique is proposed for determining validity for an operation of a device based on system call execution information on an OS executed by the device in a system to be analyzed. The system call is a scheme for a program to use a resource managed by the OA, and the system call execution information includes a system call name and an argument. In this technique, it is determined that the device matches a fraudulent pattern and that corresponds to a system call execution history involves a problem in security.

In this technique, the validity for the operation of the device can be determined based on a processing performed by an application executed on the system. However, there is a problem in which the validity cannot be determined for treating the data in the system caused by a security issue not due to attack or failure.

Also, a technique is disclosed for generating a data transport route based on program operational information in which operational specification for a program is described, and for validating whether the data transport route violates security by determining whether to match a preset policy. In this technique, a behavior of the program in a system to be analyzed is modeled as the data transport route, and it is determined whether the data transport route violates the security.

In this technique, the data transport route is generated based on the information in which the operational specification for the program is described. The “information in which the operational specification for the program is described” is security setting information and information including a type of node and arc created in the model, and is not information indicating the behavior of the program when actually executing the program. Therefore, if the data is exchanged in the data transport route not generated based on the “information in which the operational specification for the program is described”, there is an issue in which it cannot be validated whether to violate the security. On the other hand, in order to reduce defeat for the data transport route in analyzing the security risk, it is necessary to describe the operational specification for the program in detail, and the problem cannot be solved in which cost and time required for analyzing the security risk are increased.

In view of the above-mentioned context, an object of the present example embodiment is to determine whether to involve security risk based on an actual data flow in a system to be analyzed.

### (2) Technical Feature

According to the example embodiments of the present invention, an analysis apparatus includes a historical information collecting unit configured to collect historical information on an operational history of a program executed in a system to be analyzed, an information adding unit configured to add to the historical information, external information obtained from an information resource other than an information processing apparatus that executes the program, and a risk determining unit configured to perform a risk determining processing for determining based on a preset determining condition, whether the historical information to which the external information is added involves security risk.

According to the above, it can be determined whether to involve the security risk based on the actual data flow in the system to be analyzed. It is noted that the above-mentioned technical feature is merely a specific example of the example embodiments of the present invention, and as a matter of course, the example embodiment of the present invention is not limited to the above-mentioned technical feature.

### 2. First Example Embodiment

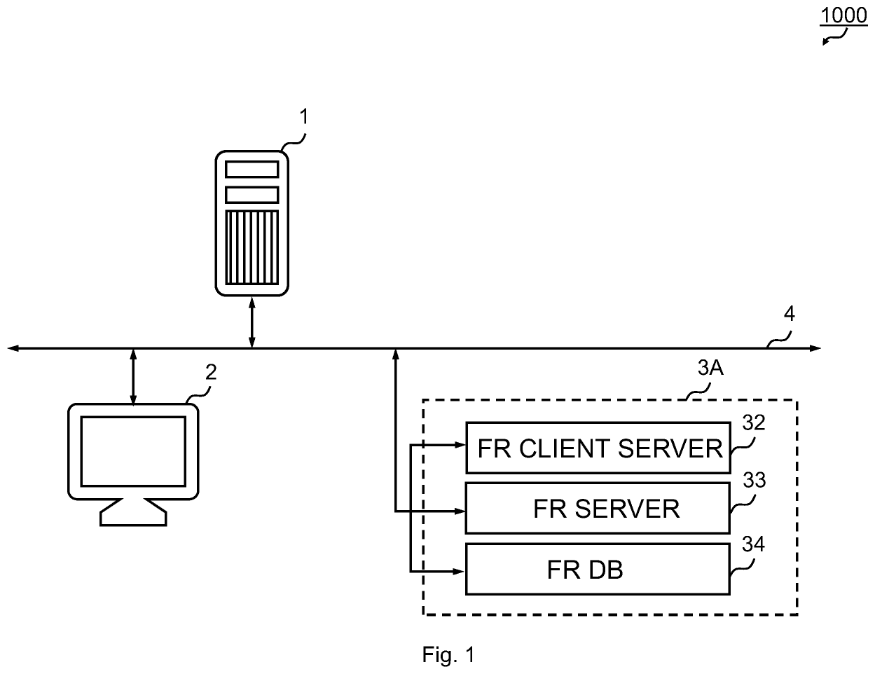

Hereinafter, with reference to FIG. 1 to FIG. 10, an example embodiment of the present invention is described. According to the present example embodiment, an analysis system configured to analyze security risk in a system that provides an authentication service over a network is described.

### 2.1. Operational Style of Analysis System

Firstly, an operational style of an analysis system 1000 is described according to a first example embodiment. FIG. 1 is a diagram illustrating the operational style of the analysis system 1000 according to the first example embodiment. As shown in FIG. 1, the analysis system 1000 includes an analysis server 1, a user terminal 2, a FR (Facial Recognition) client server 32, a FR (Facial Recognition) server 33 and a FRDB (Facial Recognition Data Base) 34 that are configured to be connected over a network 4.

The analysis server 1 is a server in which a program is installed for analyzing based on information obtained from a system to be analyzed, whether a data route for exchange in the system to be analyzed involves security risk. The system to be analyzed according to the present example embodiment corresponds to a system connected to the analysis server 1 over the network 4, such as an authentication system 3A.

The user terminal 2 is an information processing terminal for an operator to operate the analysis server 1, and is implemented as a PC (Personal Computer) etc. Operating the user terminal 2 by the operator allows the user terminal 2 to display a UI (User Interface) for operating the analysis server 1, and to transmit and receive the information between the user terminal 2 and the analysis server 1.

The FR client server 32, the FR server 33 and the FR DB 34 correspond to a host terminal included in the authentication system 3A that provides the authentication service for authenticating the user through facial recognition. The authentication system 3A is described in detail below.

### 2.2. Overview of Data Route for Exchange in Authentication System

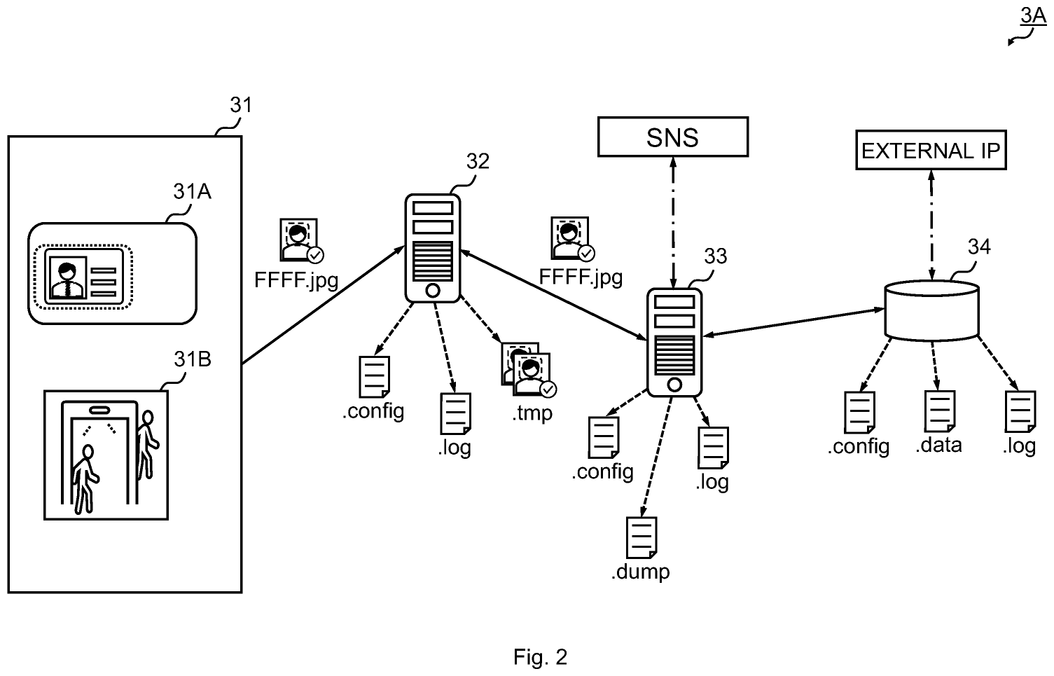

Next, with reference to FIG. 2, an overview of a data route for exchange in the authentication system 3A is described. FIG. 2 is a model diagram for describing the data route for exchange in the authentication system 3A. It is noted that according to the present example embodiment, the description is provided assuming that the authentication system 3A provides the authentication service for authenticating the user through the existing facial recognition technique.

The authentication system 3A includes a user information obtaining module 31, the FR client server 32, the FR server 33 and the FR DB 34. The user information obtaining module 31, the FR client server 32, the FR server 33 and the FR DB 34 are interconnected over a network different from the network 4 (see FIG. 1).

As the user information obtaining module 31, an ID reader and a camera etc. can be used, the ID reader is capable of reading from an IC chip embedded in a card, user information including a user facial image, and the camera images as user information, a facial image of user who passes a gate etc. The user information obtained by the user information obtaining module 31 is transmitted to the client server 32. According to the present example embodiment, an information route for exchange in the authentication system 3A is described as an example of a route for data including the user information obtained by the user information obtaining module 31. Also, an example of data includes a “FFFF.jpg” file indicating the user facial image, and a data file with an extension such as “.config”, “.log”, “.tmp”, “.dat” and “.dump”.

It is noted in FIG. 2, data exchange between the user information obtaining module 31, the FR client server 32, the FR server 33 and the FR DB 34 is indicated with a solid line. Also, file accessed and generated with a program executed in the FR client server 32, the FR server 33 and the FR DB 34 are indicated with a dashed line. Further, communication in the FR server 33 and the FR DB 34 with an IP (Internet Protocol) address external to the authentication system 3A is indicated with a dashed-and-dotted line.

The FR client server 32 obtains the user information (e.g., “FFFF.jpg” and a variety type of setting information on user) read by the user information obtaining module 31. The FR client server 32 generates based on the obtained user information, a data file including a file identifier for uniquely identifying the data file. For example, the FR client server 32 generates the data file with the extensions such as “.log”, “.tmp”, and so on. The data file with the extension “.log” corresponds to log data for a program executed in the FR client server 32. Also, the FR client server 32 generates a temporal data file with the extension “.tmp” including an image “FFFF.jpg”. Further, the FR client server 32 reads the data file with the extension “.config”. The data file with the extension “.config” corresponds to a setting file including data for a setting parameter such as IP address of the FR server 33 for example, and includes the file identifier for uniquely identifying the file.

The FR server 33 receives the user information from the FR client server 32. The FR server 33 generates based on the received user information, the data file including the file identifier for uniquely identifying the data file. The FR server 33 generates the data file with the extension “.log”, “.dump” and so on for example The data file with the extension “.log” corresponds to the log data for the program executed in the FR server 33. Also, the FR server 33 generates the data file with the extension “.dump” indicating that the program executed in the FR server 33 fails. Further, the FR server 33 reads the data file with the extension “.config”. The data file with the extension “.config” corresponds to the setting file including data for the setting parameter such as IP address of the FR DB 34 for example, and includes the file identifier for uniquely identifying the file.

Yet further, the FR server 33 communicates with a SNS (Social Networking Service) implemented in an information resource that is assigned with the IP address external to the authentication system 3A.

The FR DB 34 receives and stores the user information from the FR server 33. Also, the FR DB 34 generates based on the received user information, the data file including the file identifier for uniquely identifying the data file. The FR DB 34 generates the data file with the extensions “.log”, “.dump” and so on for example. The data file with the extension “.log” corresponds to the log data for the program executed in the FR DB 34. Further, the FR DB 34 generates the data file with the extension “.dat” including a certain type of data. Yet further, the FR DB 34 reads the data file with the extension “.config”. The data file with the extension “.config” corresponds to the setting file including the setting parameter such as location in which the data for the FR DB 34 is stored for example, and includes the file identifier for uniquely identifying the file.

In this way, a wide variety of data is generated and exchanged in the authentication system 3A by executing the program in the authentication system 3A. However, the data generated or exchanged with execution of the program executed in the authentication system 3A is not necessarily used for the authentication service provided by the authentication system 3A. Also, some of the data generated or exchanged in the authentication system 3A is considered to involve security risk as below.

For example, in the data route for exchange in the authentication system 3A, the data including personal information such as the user information may expose to the IP external to the authentication system 3A such as SNS. The situation in which the data including the personal information may expose to the IP external to the authentication system 3A is not preferred from the viewpoint of security. Also, it is not considered that it is preferred from the viewpoint of security, that data remains, for example, the temporal data file with the extension “.tmp” remains in the same directory beyond a predetermined time. Further, the data file with the extension “.dump” is a file generated for analyzing the cause if the executing program fails during the system development. Therefore, it is not considered that it is preferred from the viewpoint of security that the data file with the extension “.dump” is generated in a production environment of the authentication system 3A.

The information on the above-mentioned data generated or exchanged with execution of the program executed in the authentication system 3A can be obtained as follows in the authentication system 3A. For example, the information can be obtained by the authentication program executed in the authentication system 3A obtaining a system call invoked when using a resource for each host (storage medium, memory, and so on) and snapshotting the authentication system 3A during execution of the authentication program. The system call and snapshot of the authentication system 3A is information generated by executing the program (authentication program in this case) executed in the authentication system 3A. In other word, the system call and snapshot of the authentication system 3A corresponds to historical information on an operational history for the program executed in the authentication system 3A. Hereinafter, the system call and snapshot of the system to be analyzed such as the authentication system 3A may be referred to as “historical information”.

According to the present example embodiment, an analysis server 1 obtains the historical information from the authentication system 3A and analyzes whether the data route for exchange in the authentication system 3A involves the security risk.

### 2.3. Configuration of Analysis Server

Next, a configuration of the analysis server 1 is described according to the present example embodiment. Firstly, a hardware configuration of an information processing apparatus such as the analysis server 1, the user terminal 2 and a host terminal as the system to be analyzed included in the authentication system 3A is described, and the functional configuration of the analysis server 1 is described.

### 2.3.1. Hardware Configuration of Information Processing Apparatus such as Analysis Server

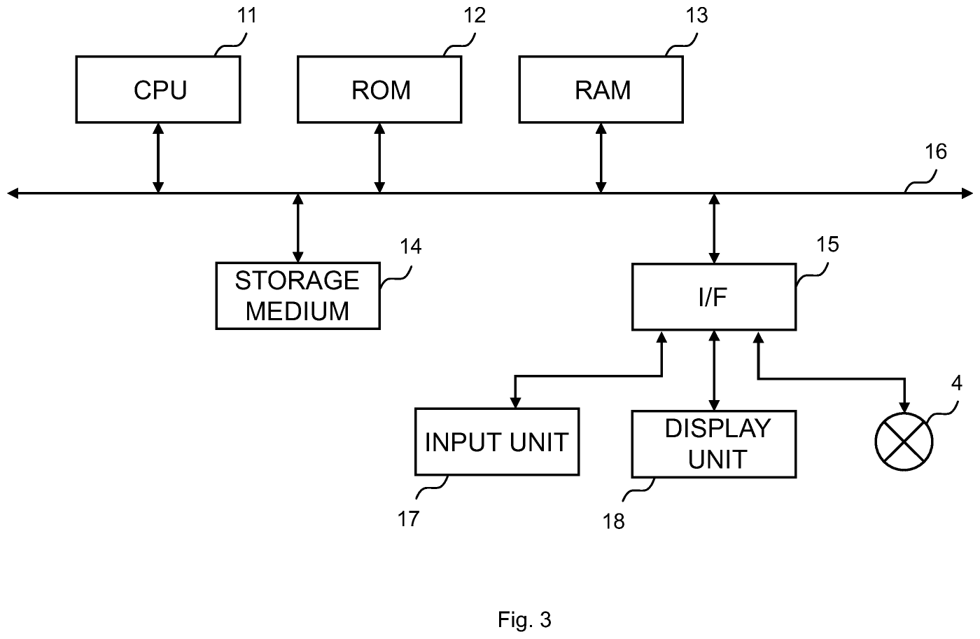

With reference to FIG. 3, the hardware configuration of the information processing apparatus such as the analysis server 1, the user terminal 2 and the host terminal included in the authentication system 3A is described. FIG. 3 is a block diagram showing the hardware configuration of the information processing apparatus.

The information processing apparatus includes a CPU (Central Processing Unit) 11, a RAM (Random Access Memory) 12, a ROM (Read Only Memory) 13, a storage medium 14, and an interface (I/F) 15 that are interconnected via a bus 16. Also, an input unit 17, a display unit 18, and a network 4 are connected to the I/F 15.

The CPU 11 is a calculating means and controls an entire operation of the information processing apparatus. The RAM 12 is a volatile storage medium on which the data can be read and written at high speed, and is used as a working area when the CPU 11 processes the information. ROM 13 is a read only non-volatile storage medium and stores program such as firmware. The storage medium 14 is a non-volatile storage medium on which the information can be read and written, such as an HDD (Hard Disk Drive) and stores OS (Operating System), a variety of control program, application and program, and so.

The I/F 15 connects the bus 16 to a variety of hardware and network, and controls them. The input unit 17 is an input apparatus for the user to input the information in the information processing apparatus, such as a keyboard and a mouse. The display unit 18 is a display apparatus for the user to confirm the status of the information processing apparatus, such as an LCD (Liquid Crystal Display). It is noted that the input unit 17 and the display unit 18 can be omitted.

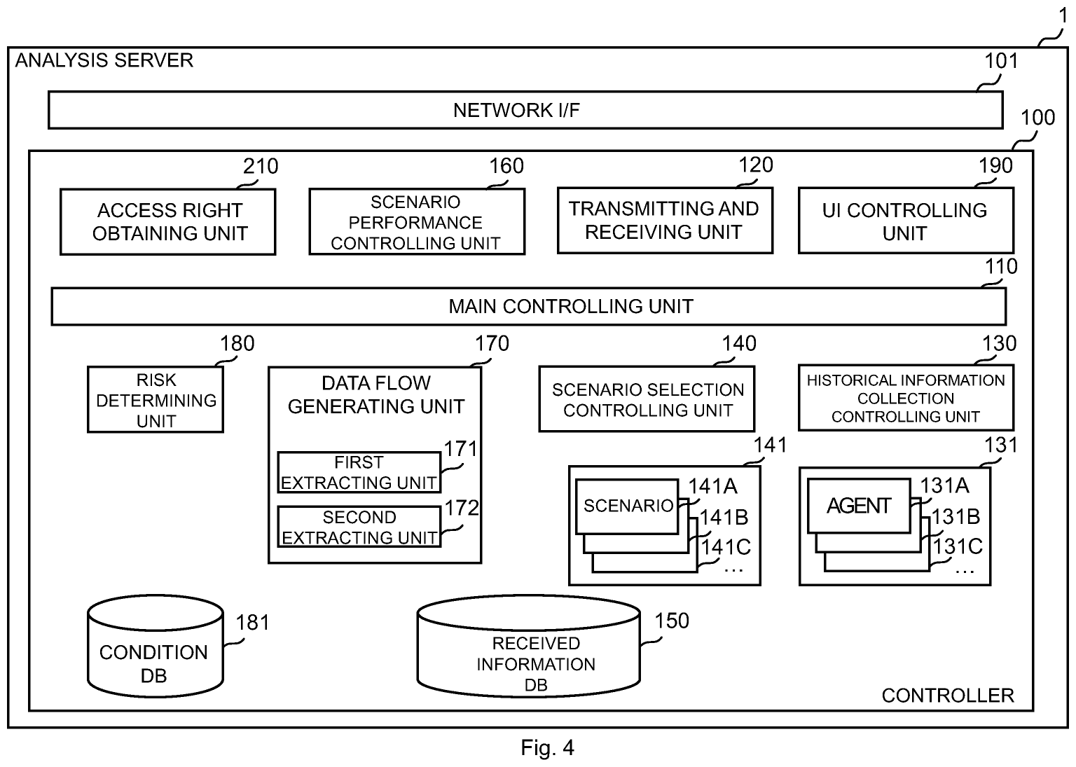

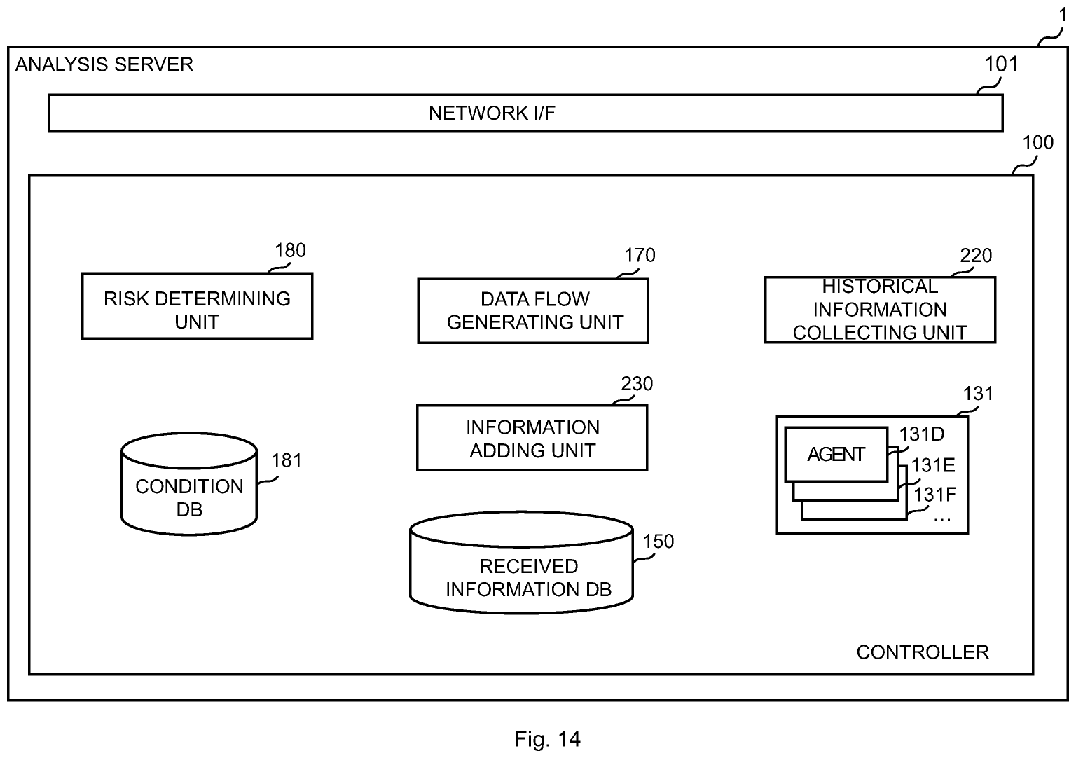

In this hardware configuration, a software controlling unit is configured in the analysis server 1 by the CPU 11 in the analysis server 1 performing the calculation according to the program stored on the ROM 13 in the analysis server 1 and the program loaded from the storage medium 14 in the analysis server 1 to the RAM 12 in the analysis server 1. Then, a functional block is configured for implementing a function of a controller 100 (see FIG. 4 and FIG. 14) in the analysis server 1 by a combination of the above configured software controlling unit and the hardware.

### 2.3.2. Functional Configuration of Analysis Server

Next, with reference to FIG. 4, the functional configuration of the analysis server 1 is described. FIG. 4 is a functional block diagram showing the functional configuration of the analysis server 1. As shown in FIG. 4, the analysis server 1 includes a controller 100 and a network I/F 101.

The controller 100 manages obtainment of the historical information from the system to be analyzed, generation of the data flow information indicating the data route in the system to be analyzed, and analysis of the security risk based on the data flow information. The controller 100 is configured by installing a dedicated software program in the information processing apparatus such as the analysis server 1. This software program corresponds to the analysis program according to the present example embodiment.

In the controller 100, a main controlling unit 110 controls an entire operation of the controller 100. Therefore, the main controlling unit 110 instructs each unit of the controller 100 to perform the processing in implementing each function in the controller 100 as described above.

A transmitting and receiving unit 120 exchanges the information with the system to be analyzed via the network I/F 101. The transmitting and receiving unit 120 performs establishment of communication with the system to be analyzed and reception of the information output from the system to be analyzed to the analysis server 1 for example. As one of the above functions, the transmitting and receiving unit 120 receives the information collected by agents 131A, 131B and 131C in the system to be analyzed and a snapshot of the system to be analyzed, that is, receives the historical information.

A historical information collection controlling unit 130 controls performance of a collecting processing by the agents 131A, 131B and 131C that perform the collecting processing for collecting the historical information in the system to be analyzed. The agents 131A, 131B and 131C are stored on an agent storing unit 131. Specifically, the historical information collection controlling unit 130 installs agents 131A, 131B and 131C for each of the host terminals (FR client server 32, FR server 33 and FR DB 34) included in the system to be analyzed (authentication system 3A) firstly. Then, the historical information collection controlling unit 130 controls start and termination of the collecting processing by the installed agents 131A, 131B and 131C.

The agent according to the present example embodiment is a software module installed for the host terminal included in the system to be analyzed. It is noted that the agent may be designed such that control by the historical information collection controlling unit 130 enables to perform the collecting processing in order not to prevent the calculation performed in the host terminal. Further, the agent may be designed as to being uninstalled automatically from the host terminal included in the system to be analyzed after transmitting the collected historical information to the analysis server 1. A specific procedure of the collecting processing by the agent is described in detail below.

The historical information collected by the agents 131A, 131B and 131C in the system to be analyzed is transmitted to the transmitting and receiving unit 120 via the network I/F 101. The main controlling unit 110 stores in a received information DB (Data Base) 150, the historical information received by the transmitting and receiving unit 120, in association with scenarios 141A, 141B and 141C described below. Also, the main controlling unit 110 stores, if obtaining access right information described below, the access right information in the received information DB 150.

A scenario selection controlling unit 140 selects a scenario as a processing causing the system to be analyzed to perform, the scenario is information in which a plurality of preset processings are described. Specifically, the scenario selection controlling unit 140 selects any of the scenarios 141A, 141B and 141C stored on a scenario storing unit 141 based on the information received from the user terminal 2.

It is noted that the scenario selection controlling unit 140 may call from an external apparatus connected to the analysis server 1, a test code generated for a purpose of analyzing the operation of the system to be analyzed. In this case, the test code generated for the purpose of analyzing the operation of the authentication system 3A corresponds to the scenario.

For example, it is assumed that in the scenario 141A, “a processing of passing to the FR server 33 the user information received by the FR client server 32”, “a processing of performing for the user information received by the FR client server 32 the user authentication in the FR server 33” and “a processing of storing on the FR DB 34 the user information on the user authenticated in the FR server 33 and managing the user information” are described.

Also, it is assumed that in the scenario 141B, “a processing by the FR server 33 of referring the user information stored on the FR DB 34”, “a processing of passing to the FR server 33 the user information received by the FR client server 32” and “a processing of performing the user authentication based on the user information received from the FR client server 32 and the user information referred in the FR DB 34” are described.

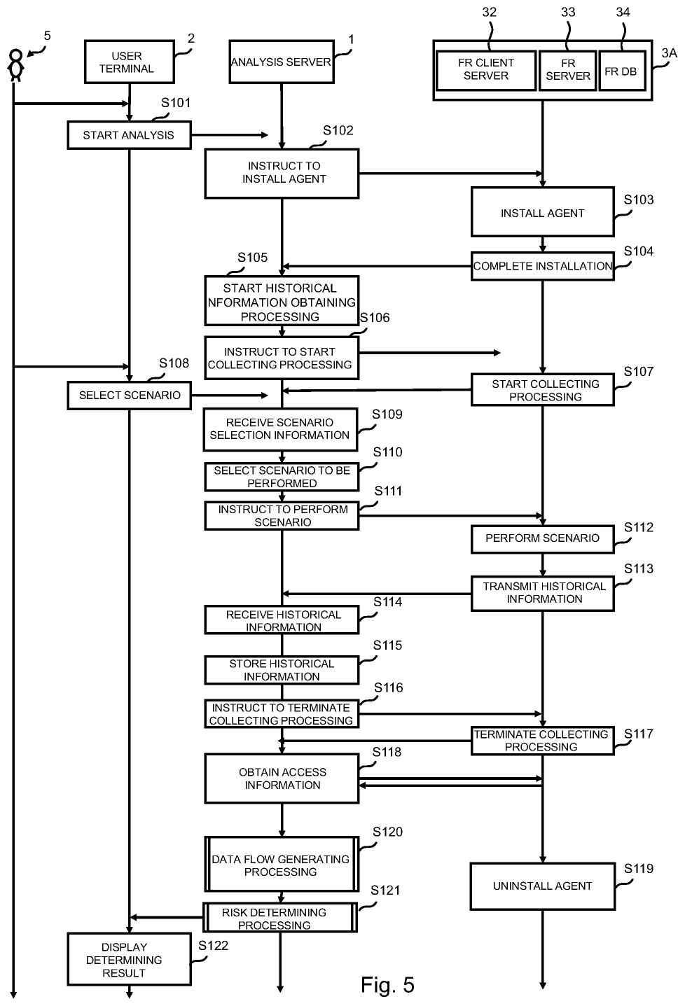

The scenario selection controlling unit 140 may generate the scenario 141C in addition to the scenarios 141A and 141B, based on the information in which a result of processing that can be performed in the system to be analyzed is designated. The information in which the result of processing that can be performed in the system to be analyzed is designated is transmitted from the user terminal 2 to the analysis server 1, based on an operation by the operator 5 (see FIG. 5) for the user terminal 2.

A scenario performance controlling unit 160 causes the system to be analyzed to perform the scenario selected by the scenario selection controlling unit 140. It is noted that the scenario performance controlling unit 160 may cause the system to be analyzed to perform the scenario by calling as the scenario from the external apparatus connected to the analysis server 1, the test code generated for the purpose of analyzing the operation of the system to be analyzed. In causing the system to be analyzed to perform the processing described in the scenario, the scenario performance controlling unit 160 starts the performance of a plurality of processings described in the scenario after collecting processing starts by the agent installed in the system to be analyzed. Then the scenario performance controlling unit 160 terminates the collecting processing by the agent after the plurality of processings described in the scenario terminate in the system to be analyzed. That is, the scenario performance controlling unit 160 functions as a processing performance controlling unit according to the present example embodiment.

An access right obtaining unit 210 obtains based on the historical information, access right information on a file exchanged in the system to be analyzed. For example, if causing the authentication system 3A to perform the scenario 141A, the access right obtaining unit 210 obtains, by performing the scenario 141A, based on the historical information etc., the information on the access right (hereinafter referred to as “access right information”) that is set for the file accessed by the program executed in the authentication system 3A. It is noted that it may cause the agent installed in the system to be analyzed to obtain the access right information.

A data flow generating unit 170 performs a data flow information generating processing for generating based on the historical information received by the transmitting and receiving unit 120, the data flow information that indicates the data route for exchange in the system to be analyzed. That is, the data flow generating unit 170 corresponds to a generating unit according to the present example embodiment. Also, the data flow generating unit 170 includes a first extracting unit 171 and a second extracting unit 172.

The first extracting unit 171 extracts from the data flow information, a path including predetermined attribute information. For example, if the data flow information is the data flow graph represented in the graph structure, the predetermined attribute information corresponds to the information that indicates an attribute of a node and an edge in the data flow graph. In this case, the path including the predetermined attribute information corresponds to a subgraph that is included in the data flow graph and that includes the predetermined attribute information. Also, the path including the predetermined attribute information that is extracted by the first extracting unit 171 corresponds to a first path according to the present example embodiment. It is noted that the operator 5 (see FIG. 5) operating the user terminal 2 enables to set any attribute as the predetermined attribute information.

The second extracting unit 172 divides the data flow information into a plurality of paths firstly. If the data flow information is the data flow graph represented in the graph structure, the second extracting unit 172 divides the data flow graph into the plurality of subgraphs based on a predetermined indicator (e.g., indicator that indicates centrality of network such as betweenness centrality). Then, the second extracting unit 172 selects and extracts the longest subgraph among the plurality of subgraphs. It is noted that the second extracting unit 172 may select and extract the subgraph including the most nodes or hosts among the plurality of subgraphs. In this way, the second extracting unit 172 divides the data flow information into the plurality of paths to extract the longest path or the path including the most nodes or hosts among the plurality of subgraphs. The path extracted by the second extracting unit 172 from the data flow information corresponds to a second path according to the present example embodiment. The flow in the data flow information generating processing is described below.

A risk determining unit 180 performs a risk determining processing for determining based on a determining condition stored on a condition DB (Data Base) 181, whether the data flow information involves security risk. Specific procedure in the risk determining processing is described below.

The condition DB 181 is a data base for storing the determining condition that includes any one of the followings. According to the present example embodiment, the determining condition stored on the condition DB 181 includes at least one of the information on the attribute of the node and the edge in the graph that indicates the data route, the information on the access right to the node, and the information on the operation for the information resource included in the node. The determining condition may be generated based on the vulnerability information on the system (e.g., CWE: Common Weakness Enumeration) etc. Also, the determining condition stored on the condition DB 181 may include the information that indicates a risk indicator employed in the existing security risk determination scheme such as CVSS (Common Vulnerability Scoring System) and DREAD.

A UI (User Interface) controlling unit 190 controls a UI displayed in the user terminal 2, for example, controls to reflect the result of the risk determining processing on the UI displayed in the user terminal 2. The user terminal 2 corresponds to a display apparatus for displaying the result of the risk determining processing, and the UI controlling unit 190 functions as a display controlling unit for causing the user terminal 2 to display the result of the risk determining processing. Also, the UI controlling unit 190 may cause the user terminal 2 to display the UI for designating the result of the processing that can be performed in the system to be analyzed.

According to the above-described configuration, the analysis server 1 according to the present example embodiment obtains the historical information from the system to be analyzed, and analyzes whether the data route for exchange in the system to be analyzed involves the security risk.

### 2.4. Overview of Processing in Analysis System

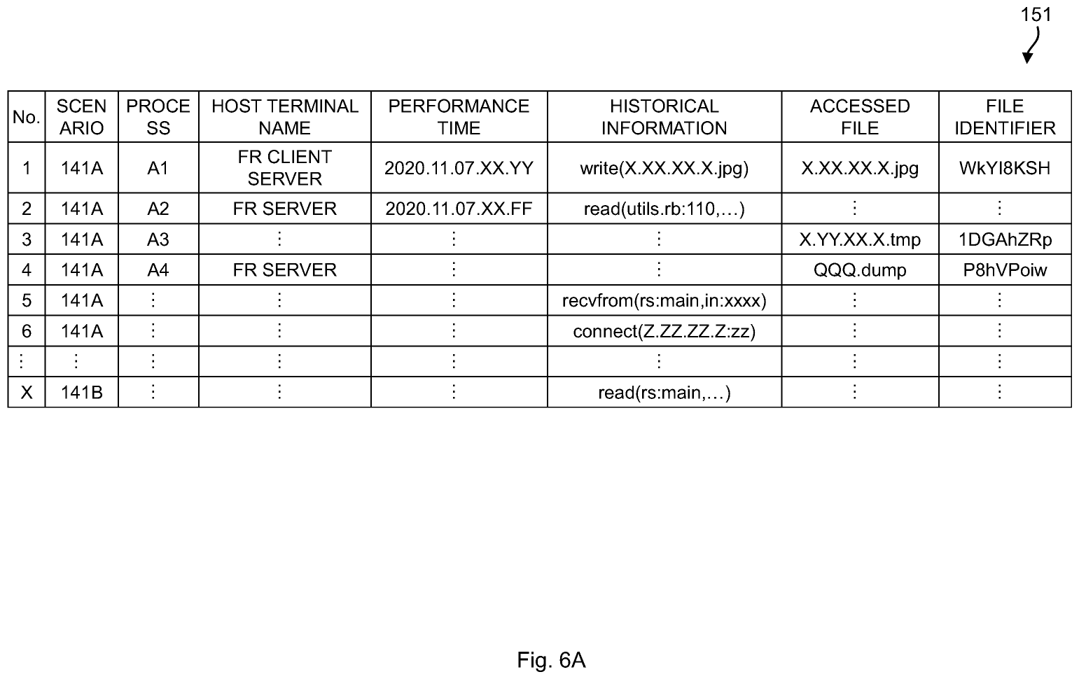

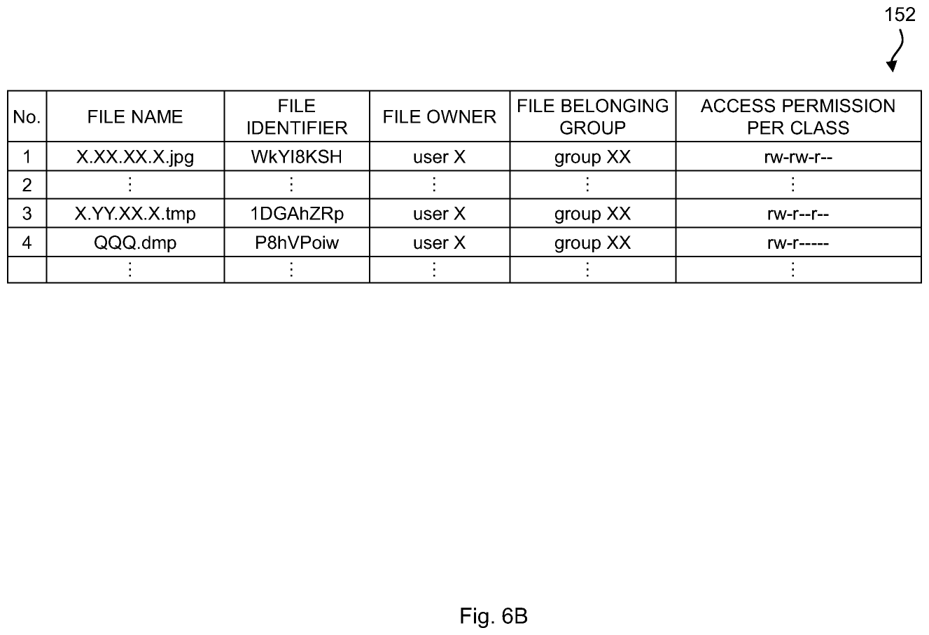

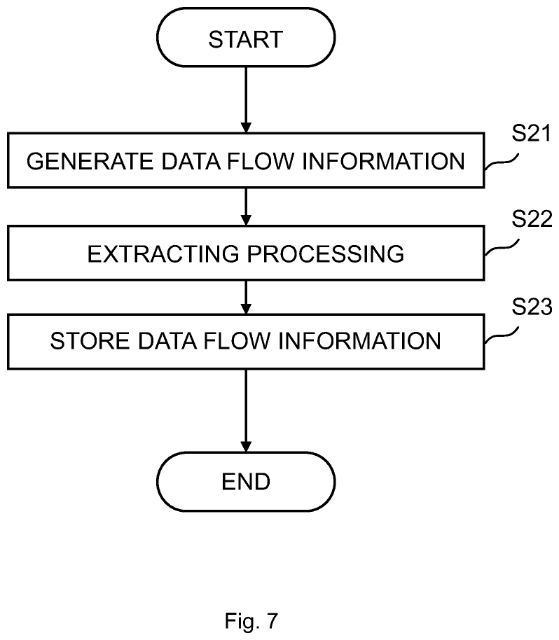

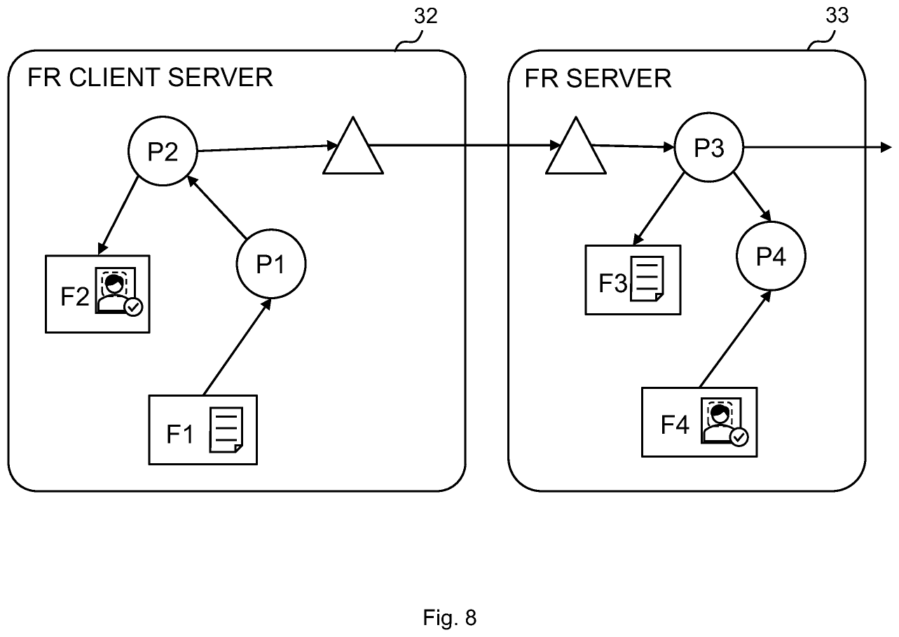

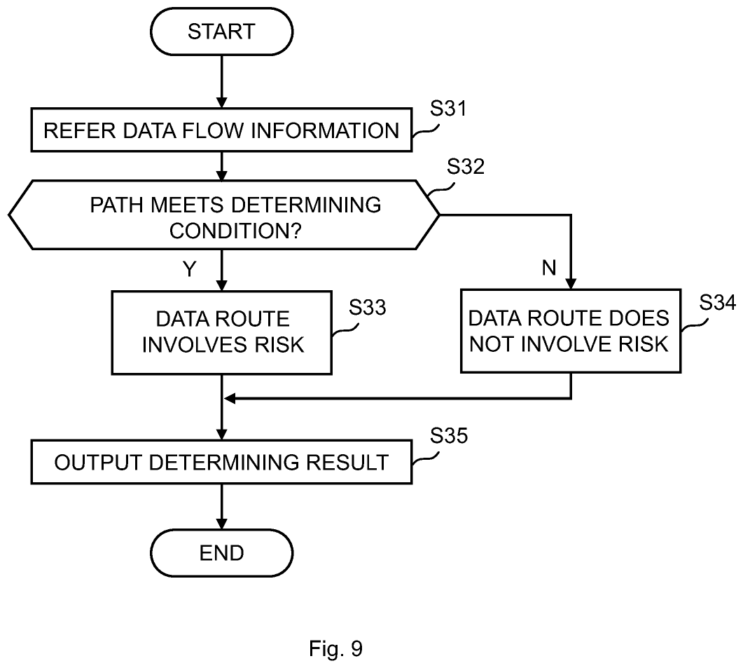

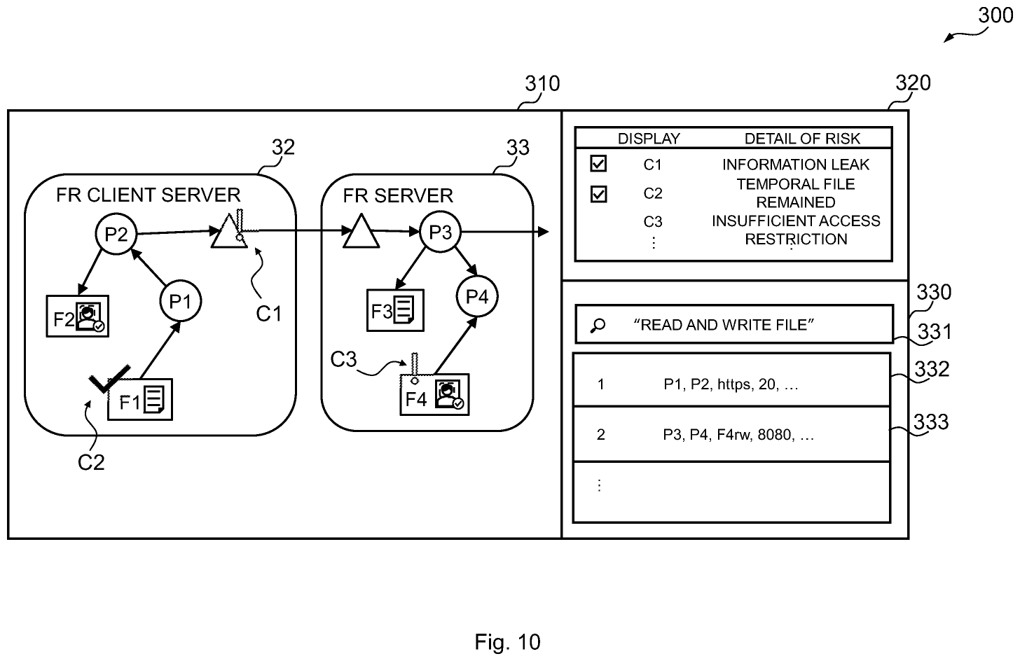

Next, with reference to FIG. 5 to FIG. 10, an overview of the processing in the analysis system 1000 is described according to the present example embodiment. FIG. 5 is a sequence diagram showing a flow in the processing in the analysis system 1000. FIG. 6A is a diagram illustrating a structure of a historical information data table 151 stored on a received information DB 150. FIG. 6B is a diagram illustrating a structure of an access right information data table 152 stored on the received information DB 150. FIG. 7 is a flowchart showing a flow in the data flow information generating processing in the analysis server 1. FIG. 8 is a diagram showing an example of the data flow information according to the present example embodiment. FIG. 9 is a flowchart showing a flow in the risk determining processing in the analysis server 1. FIG. 10 is a diagram showing an example of a GUI 300 on which the analysis result of the risk determining processing is displayed according to the present example embodiment.

### 2.4.1. Flow in Processing in Analysis System

Firstly, with reference to FIG. 5, the overview of the processing in the analysis system 1000 is described. In FIG. 5, the operator 5 for the analysis system 1000 operates to start on the user terminal 2, the security risk analysis in the analysis system 1000. It is assumed that the operation for staring the security risk analysis is performed for the authentication system 3A as the system to be analyzed. The user terminal 2, in step S101, transmits to the analysis server 1, the information indicating the start of the security risk analysis in the authentication system 3A.

The analysis server 1 (historical information collection controlling unit 130), in step S102, instructs to install the agents 131A, 131B and 131C that perform the collecting processing for collecting the historical information. The analysis server 1 instructs each of three host terminals included in the authentication system 3A to install agents 131A, 131B and 131C respectively.

As mentioned above, according to the present example embodiment, the FR client server 32, the FR server 33 and the FR DB 34 are included as the host terminal in the authentication system 3A. In this case, the analysis server 1 instructs the FR client server 32 to install the agent 131A, instructs the FR server 33 to install the agent 131B, and instructs the FR DB 34 to install the agent 131C. In the following description, the FR client server 32, the FR server 33 and the FR DB 34 may be referred to as “the host terminal in the authentication system 3A”, and the gents 131A, 131B and 131C may be referred to as “the agent” if it is not necessary to distinguish them.

The host terminal in the authentication system 3A, in step S103, installs the agent. Upon completing the installation of the agent, the host terminal in the authentication system 3A, in step S104, transmits to the analysis server 1, completion notification information indicating that the installation of the agent is completed. Completing the installation of the agent enables the host terminal in the authentication system 3A to be in a state in which the collecting processing can start.

Upon receiving the completion notification information, the analysis server 1 (main controlling unit 110), in step S105, starts a historical information obtaining processing. Upon starting the historical information obtaining processing, in step S106, the historical information collection controlling unit 130 transmits an instruction for starting the collecting processing to the host terminal in the authentication system 3A. As a result, the instruction for starting the collecting processing is transmitted from the analysis server 1 to the host terminal in the authentication system 3A on which the agent is installed.

Upon receiving the instruction for starting the collecting processing, in step S107, the agent starts the collecting processing for the historical information in the host terminal in the authentication system 3A on which the agent is installed.

The operator 5 operates the user terminal 2 to select the scenario (e.g., scenario 141A) to be performed by the authentication system 3A. In step S108, the user terminal 2 transmits to the analysis server 1, scenario selection information indicating that the scenario 141A is selected. It is noted that for the user terminal 2, if the scenario is selected in conjunction with the operation for starting the security risk analysis, step S101 and step S108 may be performed concurrently.

The transmitting and receiving unit 120, in step S109, receives the scenario selection information transmitted in step S108 from the user terminal 2. It is assumed that as the scenario to be performed, the scenario selection information is received indicating that the scenario 141A is designated. The scenario selection controlling unit 140, in step S110, selects based on the scenario selection information, the scenario 141A among the scenarios stored on the scenario storing unit 141. Next, the scenario selection controlling unit 140, in step S111, transmits to the host terminal in the authentication system 3A, a scenario performance instruction for designating the scenario 141A as the scenario to be performed, as well as the scenario 141A.

The host terminal in the authentication system 3A, in step S112, performs the processing described in the scenario that is designated in the scenario performance instruction. That is, in step S112, “the processing for passing to the FR server 33, the user information received by the FR client server 32”, “the processing for performing in the FR server 33, the user authentication for the user information received from the FR client server 32”, “the processing for storing and managing in the FR DB 34, the user information on the user authenticated in the FR server 33” and so on are performed that are described in the scenario 141A in the authentication system 3A.

Upon performing the processing according to the scenario 141A, in step S113, the host terminal in the authentication system 3A transmits to the analysis server 1, the historical information collected by the agent.

The transmitting and receiving unit 120, in step S114, receives the historical information transmitted in step S113 from the host terminal in the authentication system 3A, and passes to the main controlling unit 110. The main controlling unit 110, in step S115, stores on the received information DB 150, the historical information associating with the information on the scenario 141A.

The analysis server 1 (main controlling unit 110) receives, in step S115, and stores the historical information, and after that, in step S116, transmits a collecting processing termination instruction to the host terminal in the authentication system 3A on which the agent is installed. The host terminal in the authentication system 3A that received the collecting processing termination instruction from the analysis server 1, in step S117, terminates the collecting processing by the agent for the historical information. Also, the analysis server 1 terminates the historical information obtaining processing by transmitting the collecting processing termination instruction.

Upon terminating the historical information obtaining processing, in step S118, the analysis server 1 (access right obtaining unit 210) obtains based on the historical information, the access right information on the file accessed by the program that is executed in the authentication system 3A in performing the scenario. It is noted that it may cause the agent installed in the authentication system 3A in step S103 to obtain the access right information. The obtained access right information is stored on the received information DB 150.

With reference to FIG. 6A and FIG. 6B, a structure of the information stored on the received information DB 150 is described. Firstly, with reference to FIG. 6A, the structure of the historical information data table 151 stored on the received information DB 150 is described. As shown in FIG. 6A, according to the present example embodiment, the information on the scenario and the historical information are associated and stored. In FIG. 6A, an identifier for identifying the scenarios 141A, 141B and 141C . . . stored as the information on the scenario on the scenario storing unit 141 is illustrated, and alternatively the information on allowing to identify the processing performed by the system to be analyzed may be employed as the information on the scenario.

In FIG. 6A, the information is stored on the historical information data table 151 as an example with “′SCENARIO: 141A”, “PROCESS NAME: A1”, “HOST TERMINAL NAME: FR CLIENT SERVER”, “PERFORMANCE TIME: 2020.11.07.XX.YY”, “HISTORICAL INFORMATION: write (X.XX.XX.X.jpg)”, “ACCESSED FILE: X.XX.XX.X.jpg”, “FILE IDENTIFIER: WkYI8KSH”′ in No. 1 row. Also, the information is stored on the historical information data table 151 with “′SCENARIO: 141A”, “PROCESS NAME: 2”, “HOST TERMINAL NAME: FR SERVER”, “PERFORMANCE TIME: 2020.11.07.XX.FF”, “HISTORICAL INFORMATION: read (utils.rb:110, . . . )”′ in No. 2 row. Further, the information is stored on the historical information data table 151 with “SCENARIO: 141A”, “PROCESS NAME: A3”, “HOST TERMINAL NAME: . . . ”, “PERFORMANCE TIME: . . . ”, “HISTORICAL INFORMATION: . . . ”, “ACCESSED FILE: X.YY.XX.X.tmp”, “FILE IDENTIFIER: 1DGAhZRp”′ in No. 3 row. Yet further, the information is stored on the historical information data table 151 with “′SCENARIO: 141A”, “PROCESS NAME: A4”, “HOST TERMINAL NAME: FR SERVER”, “PERFORMANCE TIME: . . . ”, “HISTORICAL INFORMATION: . . . ”, “ACCESSED FILE: QQQ.dump”, “FILE IDENTIFIER: P8hVPoiw”′ in No. 4 row. It is noted that the IP address of the FR client server 32, the FR server 33 or the FR DB 34 may be stored as the host terminal name on the historical information data table 151.

The information stored in the No. 1 row on the historical information data table 151 corresponds to the information indicating that the FR client server 32, by performing the process A1 as the processing described in the scenario 141A with the program executed in the authentication system 3A, performs the operation indicated with “write (X.XX.XX.X.jpg)” at 2020.11.07.XX.YY, and accesses the file “X.XX.XX.X.jpg” with the file identifier “WkYI8KSH”.

The information stored in the No. 2 row on the historical information data table 151 corresponds to the information indicating that the FR server 33, by performing the process A2 as the processing described in the scenario 141A with the program executed in the authentication system 3A, performs the operation indicated with “read (utils.rb: 110, . . . )” at 2020.11.07.XX.FF.

The information stored in the No. 3 row on the historical information data table 151 corresponds to the information indicating that by performing the process A3 as the processing described in the scenario 141A with the program executed in the authentication system 3A, the file “X.YY.XX.X.tmp” with the file identifier “1DGAhZRp” is accessed.

The information stored in the No. 4 row on the historical information data table 151 corresponds to the information indicating that the FR server 33, by performing the process A4 as the processing described in the scenario 141A with the program executed in the authentication system 3A, accesses the file “QQQ.dump” with the file identifier “P8hVPoiw”.

Next, with reference to FIG. 6B, a structure of the access right information data table 152 stored on the received information DB 150 is described. According to the present example embodiment, as mentioned above, the access right information is stored on the access right information data table 152, the access right information is set for the file that is accessed by the program executed in the authentication system 3A by performing the scenario. FIG. 6B illustrates the access right information on the files “X.XX.XX.X.jpg”, “X.YY.XX.X.tmp” and “QQQ.dump” respectively that are accessed by the program executed in the authentication system 3A when performing the scenario 141A. It is noted that the access right information data table 152 shown in FIG. 6B illustrates the configuration of the access right information in UNIX (registered trademark)-like OS. Therefore, the structure of the access right information data table 152 stored on the received information DB 150 may be a data structure other than that shown in FIG. 6B.

In FIG. 6B, the information is stored on the access right information data table 152 with “FILE NAME: X.XX.XX.X.jpg”, “FILE IDENTIFIER: WkYI8KSH”, “FILE OWNER”: user X”, “FILE BELONGING GROUP: group XX”, “ACCESS PERMISSION PER CLASS: rw-rw-r- -” in No. 1 row. Also, the information is stored on the access right information data table 152 with “′FILE NAME: X.YY.XX.X.tmp”, “FILE IDENTIFIER: 1DGAhZRp”, “FILE OWNER”: user X”, “FILE BELONGING GROUP: group XX”, “ACCESS PERMISSION PER CLASS: rw-r--r--”′ in No. 2 row. Further, the information is stored on the access right information data table 152 with “′FILE NAME: QQQ.dump”, “FILE IDENTIFIER: P8hVPoiw”, “FILE OWNER”: user X”, “FILE BELONGING GROUP: group XX”, “ACCESS PERMISSION PER CLASS: rw-r - - - ” in No. 3 row.

Among the information stored on the access right information data table 152, the file identifier is information on linking the access right information stored on the access right information data table 152 and the information stored on the historical information data table 151. For example, the information indicating “FILE IDENTIFIER: WkYI8KSH” is stored on the access right information data table 152 with the No. 1 row. The information corresponding to “FILE IDENTIFIER: WkYI8KSH” is stored on the historical information data table 151 with the No. 1 row. That is, the access right information stored on the access right information data table 152 with the No. 1 row corresponds to information indicating the access right for the file “X.XX.XX.X.jpg” that is accessed by the operation performed in 2020.11.07.XX.YY in the FR client server 32 and indicated with WRITE (X.XX.XX.X.jpg), the operation is performed as the processing described in the scenario 141A with the program executed in the authentication system 3A, by performing the process A1.

The analysis server 1, in step S118, obtains the access right information on the file that is identified with the file identifier stored on the historical information data table 151. It is noted that the same is applicable to the case that the agent obtains the access right information by installing the authentication system 3A in step S103.

Among the information stored on the access right information data table 152, for the access permission per class, the permission for read, write and execute are set per class for the user. For example, it is assumed that strings stored as the access permission per class associated with “FILE NAME: K2” are “rwxrw-r--”. In this case, for setting the permission for the user class, the right for read, right for write right and right for execute are assigned for “FILE NAME: K2”. Also, in this case, for setting the permission for group class, the read right and the write right are assigned for “FILE NAME: K2”. Further, in this case, for setting the permission for other class, only the read right is assigned for FILE NAME: K2”.

The setting of the access permission is described as an example of “FILE NAME: X.XX.XX.X.jpg” stored in the No. 1 row among the access right information in the access right information data table 152 shown in FIG. 6B. As shown in FIG. 6B, for the file “FILE NAME: X.XX.XX.X.jpg”, “FILE OWNER: user X”, “FILE IDENTIFIER: WkYI8KSH”, “FILE BELONGING GROUP: group XX” and “ACCESS PERMISSION PER CLASS: rw-rw-r--” are associated and stored. This access right information indicates that the file owner for “FILE NAME: X.XX.XX.X.jpg” is user X, and the permission setting for the user class is applied to user X. Also, this access right information indicates that for the file “FILE NAME: X.XX.XX.X.jpg”, the permission setting for the group class is applied to the member with the group class being “group XX”, and the permission setting for the other class is applied to the member with the group class not being “group XX”.

Also, the “ACCESS PERMISSION PER CLASS: w-rw-r--” associated with the file “FILE NAME: X.XX.XX.X.jpg” indicates that the read right and the write right are assigned to the file “FILE NAME: X.XX.XX.X.jpg” in setting the permission for the user class. In other word, the read right and the write right are assigned to user X for the file “FILE NAME: X.XX.XX.X.jpg”, each of the read right and the write right is the permission for the user class. Also, it indicates that the read right and the write right are assigned to the member with the group class being group XX for the file “FILE NAME: X.XX.XX.X.jpg”. Further, it indicates that the read right is assigned to the member with the group class not being group XX for the file “FILE NAME: X.XX.XX.X.jpg”.

In this way, the access right information set in the file that is accessed by the program executed in the authentication system 3A is stored on the access right information data table 152. Upon the historical information and the access right information are stored on the received information DB 150, in step S119, the agent is uninstalled in the host terminal in the authentication system 3A.

Next, in step S120, the analysis server 1 (data flow generating unit 170) performs the data flow information generating processing. The data flow information generating processing allows the data flow information to be generated that indicates the data route for exchange in the system to be analyzed. The data flow information generating processing is described in detail below.

Then, in step S121, the analysis server (risk determining unit 180) performs the risk determining processing based on the data flow information, and transmit the determination result to the user terminal 2. In the risk determining processing, it is determined whether the data route indicated in the data flow information involves the security risk based on the determining condition stored on the condition DB 181. The risk determining processing is described in detail below.

Upon receiving the determination result of the risk determining processing, in step S122, the user terminal 2 displays the determination result of the risk determining processing. According to the present example embodiment, the UI controlling unit 190 in the analysis server 1 allows the determination result of the risk determining processing to be displayed on the user terminal 2 as the GUI (Graphical User Interface).

The operator 5 can confirm whether the data route involves the security risk from the determination result of the risk determining processing displayed on the user terminal 2. According to the present example embodiment, the security risk analysis is performed according to the procedure shown in FIG. 5.

In this way, according to the present example embodiment, after the historical information collection controlling unit 130 causes the agent in the system to be analyzed to start the collecting processing for the historical information, the scenario performance controlling unit 160 causes the system to be analyzed to perform the scenario. Further, after the scenario performance controlling unit 160 causes the system to be analyzed to terminate the performance of the scenario to be performed, the historical information collection controlling unit 130 causes the agent to terminate the collecting processing for the historical information.

Therefore, according to the present example embodiment, it can be determined whether the data route in the system to be analyzed involves the security risk based on the history in which the program is actually executed in the system to be analyzed.

### 2.4.2. Flow in Data Flow Information Generating Processing in Analysis Server

Next, with reference to FIG. 7 and FIG. 8, a flow in the data flow information generating processing is described according to the present example embodiment. This processing corresponds to the processing performed in step S120 in FIG. 5. It is noted that FIG. 8 shows as an example of the data flow information, the subgraph extracted through the extracting processing by the first extracting unit 171 and the second extracting unit 172.

The main controlling unit 110 causes the data flow generating unit 170 to perform the data flow information generating processing based on the information stored on the received information DB 150. The data flow generating unit 170, in step S21, generates the data flow information based on the information stored on the received information DB 150, for example, historical information data table 151 and the access right information data table 152 (see FIG. 6A and FIG. 6B). The data flow information generated by the data flow generating unit 170 corresponds to the information on the graph indicating the data route for exchange in the system to be analyzed for example (see FIG. 8).

It is noted that as described in FIG. 6A and FIG. 6B, the information stored on the historical information data table 151 is linked, with the file identifier, to the access right information stored on the access right information data table 152. The data flow generating unit 170 may include the access right information corresponding to the file identifier included in the historical information data table 151 to generate the data flow information. In this case, the data flow generating unit 170 refers the access right information data table 152 firstly, and obtains the access right information on the data file corresponding to the file identifier included in the historical information data table 151. Then, the data flow generating unit 170 associates the access right information obtained from the access right information data table 152 with the data file to generate the data flow information.

Alternatively, the data flow generating unit 170 may include the information that specifies the access right information on the data file corresponding to the file identifier included in the historical information data table 151 to generate the data flow information. In this case, the data flow generating unit 170 includes among the access right information included in the access right information data table 152, the path that specifies the access right information corresponding to the file identifier included in the historical information data table 151 to generate the data flow information.

For the data flow information generated by the data flow generating unit 170, the first extracting unit 171 or the second extracting unit 172, in step S22, performs the extracting processing for extracting a predetermined path.

For example, the first extracting unit 171 extracts from the data flow information as the subgraph, the path including the predetermined attribute information. Also, the second extracting unit 172 extracts from the data flow information as the subgraph, the path with predetermined length. Further, the data flow information generated by the data flow generating unit 170 may be stored in the analysis server 1.

FIG. 8 shows a data flow graph that is an example of the data flow information generated by the data flow generating unit 170. The data flow graph shown in FIG. 8 is the information represented in the set of a node including the information resource such as the files F1 to F4 and an edge connected to two or more different nodes. It is assumed that in FIG. 8, the files F2 and F4 include the data “FFFF.jpg” shown in FIG. 2. For example, in the FR client server 32, as a result of the processing P2, the file F2 including the data “FFFF.jpg” is generated. Also, in the FR server 33, the file F4 including the data “FFFF.jpg” is read in the processing P4.

In this way, according to the present example embodiment, the information corresponding to the data route (data flow information) is generated based on the history in which the program is actually executed in the system to be analyzed. Upon the operator 5 operates the user terminal 2 to select the data with a predetermined attribute, the first extracting unit 171 extracts a data flow related to the selected data. In this way, it makes easier for the operator 5 to view the data route. Further, since the data flow with high relevance with the data selected by the operator 5 is extracted by the first extracting unit 171 or the second extracting unit 172, it is not necessary for the operator 5 see the data with low relevance with the selected data. Therefore, it makes easier for the operator 5 to view the data flow when actually executing the program.

### 2.4.3. Flow in Risk Determining Processing in Analysis Server

Next, with reference to FIG. 9 and FIG. 10, a flow in the risk determining processing is described according to the present example embodiment. This processing corresponds to the processing performed in step S121 in FIG. 5.

The main controlling unit 110 causes the risk determining unit 180 to perform the risk determining processing based on the data flow information generated by the data flow generating unit 170. The risk determining unit 180, in step S31, refers the data flow information generated by the data flow generating unit 170. It is noted that the data flow information referred by the risk determining unit 180 also includes the path extracted from the data flow information through the extracting processing by the first extracting unit 171 and the second extracting unit 172 (if the data flow information is the data flow graph, including the subgraph as well).

Then, the risk determining unit 180, in step S32, determines whether the data flow information referred in step S31 includes the path that meets the determining condition stored on the condition DB 181. As described above, the condition DB 181 includes at least any one of: the information on the attribute of the node and the edge in the graph that indicates the data route; the information on the access right to the node, and the information on the operation for the information resource included in the node. The determining condition may be generated base on the vulnerability information on the system (e.g., CWE: Common Weakness Enumeration). Also, the condition DB 181 may include the information indicating the indicator employed in CVSS, DREAD and so on.

According to the present example embodiment, the determining condition may be stored on the condition DB 181 for determining that it involves the risk if the file with the extension “.tmp” is not deleted, and the determining condition may be stored on the condition DB 181 for determining that it involves the risk if the access restriction to the file is not sufficient. Further, the determining condition may be stored on the condition DB 181 for determining that it involves the risk if the communication protocol is not encrypted.

It is noted that if the data flow information is generated to include the path that specifies the access right information corresponding to the file identifier included in the historical information data table 151, the risk determining unit 180 may perform the risk determining processing by obtaining from the access right information data table 152, the access right information corresponding to the information assigning the access right information.

The risk determining unit 180, in step S33, if the data flow information includes the path that meets the determining condition stored on the condition DB 181 (S32/Y), determines that the data route indicated in the data flow information involves the security risk.

The risk determining unit 180, in step S34, if the data flow information does not include the path that meets the determining condition stored on the condition DB 181 (S32/N), determines that the data route indicated in the data flow information does not involve the security risk.

Then, the risk determining unit 180, in step S35, passes the determination result in step S33 or step S34 to the main controlling unit 110, and terminates the operation.

The main controlling unit 110 passes to the UI controlling unit 190, the determination result received from the risk determining unit 180. The UI controlling unit 190 generates based on the determination result received from the main controlling unit 110, the information on displaying the GUI 300 as shown in FIG. 10, and transmits to the user terminal 2.

### 2.4.4. Treatment of Determination Result of Risk Determining Processing

Next, with reference to FIG. 10, treatment of the determination result of the risk determining processing is described according to the present example embodiment. FIG. 10 illustrates the GUI 300 that includes the information on allowing to identify the data route determined by the risk determining unit 180 as the determination result of the risk determining processing to involve the risk, and a graph panel 310 that displays the data flow graph. It is assumed that when FR client server 32 transmits the information to the FR server 33, the communication protocol from the FR client server 32 is not encrypted. In this case, the risk determining unit 180 determines that the data route between the FR client server 32 and the FR server 33 involves the risk for information leak. Then, the GUI 300 including the alert indication C1 is displayed in the user terminal 2.

Also, it is assumed that the file F1 with the extension “.tmp” is not deleted among the data files managed in the FR client server 32 for example. In this case, since the data file to be deleted remains in the FR client server 32, the risk determining unit 180 determines to involve the risk. Then, the GUI 300 including the warning indication C2 is displayed in the user terminal 2.

Also, it is assumed that the processing P4 for reading and writing the file is performed for the file F4 the extension “FFFF.jpg” among the data files managed in the FR server 33 for example. In this case, since the access restriction is not sufficient to the file F4 and there is a possibility that the important information leaks in the FR server 33, the risk determining unit 180 determines to involve the risk. Then, the GUI 300 including the alert indication C3 is displayed in the user terminal 2.

It is noted that the GUI 300 may include a risk evaluation panel 320 and a navigation panel 330, the risk evaluation panel 320 displays as the character information, the determination result of the risk determining processing.

On the risk evaluation panel 320, for example, the determination result that indicates to involve the risk in the information leak is displayed in the column of the alert indication C1, the determination result that indicates to involve the risk in the temporal file remaining is displayed in the column of the warning indication C2, and the character information that indicates the determination result for whether to involve the risk related to the insufficient access restriction is displayed in the column of the alert indication C3, respectively. Also, when the operator 5 operates the column of the alert indication C3 on the risk evaluation panel 320 by operating the user terminal 2, the alert indication C3 may be emphasized on the graph panel 310.

The navigation panel 330 includes a sort button 331 such as “READ AND WRITE FILE” for allowing the operator 5 to designate and search the information on any processing and file, and path designation buttons 332 and 333 for displaying the result of extracting the path that includes the processing and file designated from the data flow information on the sort button 331, for example. When the operator 5 operates the path designation button 333 on the navigation panel 330 by operating the user terminal 2, the alert indication C3 may be emphasized on the graph panel 310 that includes the file F4 and processing P4 indicated by the path displayed on the path designation button 333.

In this way, according to the present example embodiment, the historical information is obtained related to the operational history for the program executed in the system to be analyzed, and the data flow information is generated indicating the data route for exchange in the system to be analyzed. Then, it is determined based on the preset determining condition, whether the data route indicated in the data flow information involves the security risk. Therefore, according to the present example embodiment, it can be determined whether the data route involves the security risk, for example as to the validity for handling the data by comprehensively obtaining the information on the behavior of the program when actually executing the program.

Also, according to the present example embodiment, the processing performed by the system to be analyzed is designated as the scenario, and the processing is performed by the system to be analyzed according to the scenario. Therefore, it can be determined as to what risk is involved when performing the specific processing in the system to be analyzed with reducing the amount of data to be collected for the risk determining processing.

Further, the determination result of the risk determining processing can be displayed by operating the GUI displayed on the user terminal and designating any processing and file for the operator. In this way, the portion determined to involve the risk can be easily identified for the data route for exchange in the system to be analyzed. Therefore, it can make easier to correct the portion determined to involve the risk, and reduce the security risk in the system to be analyzed.

### 3. Modification

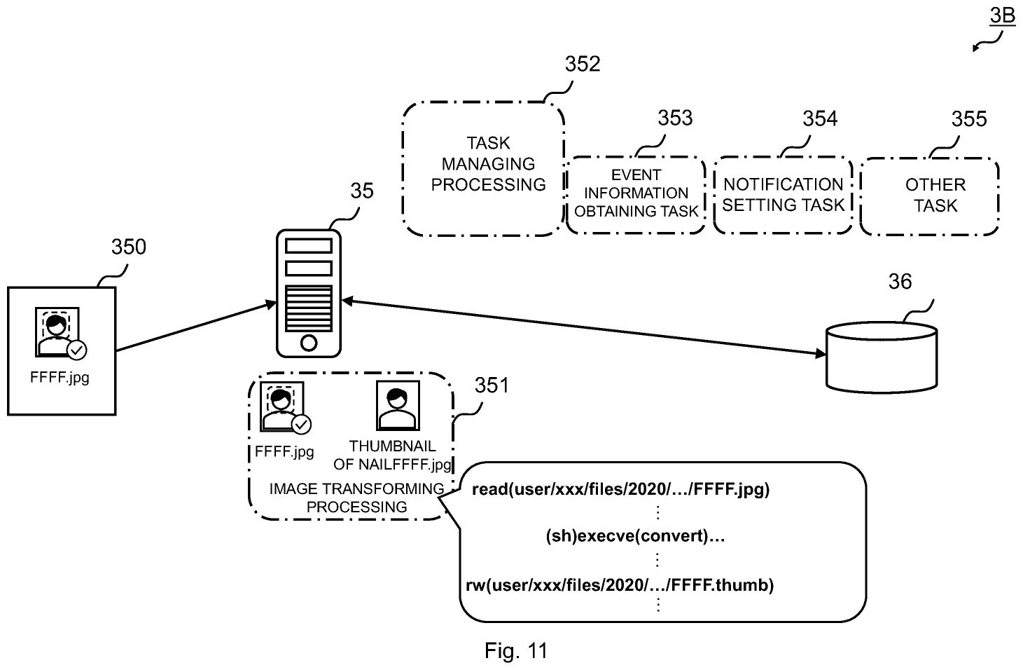

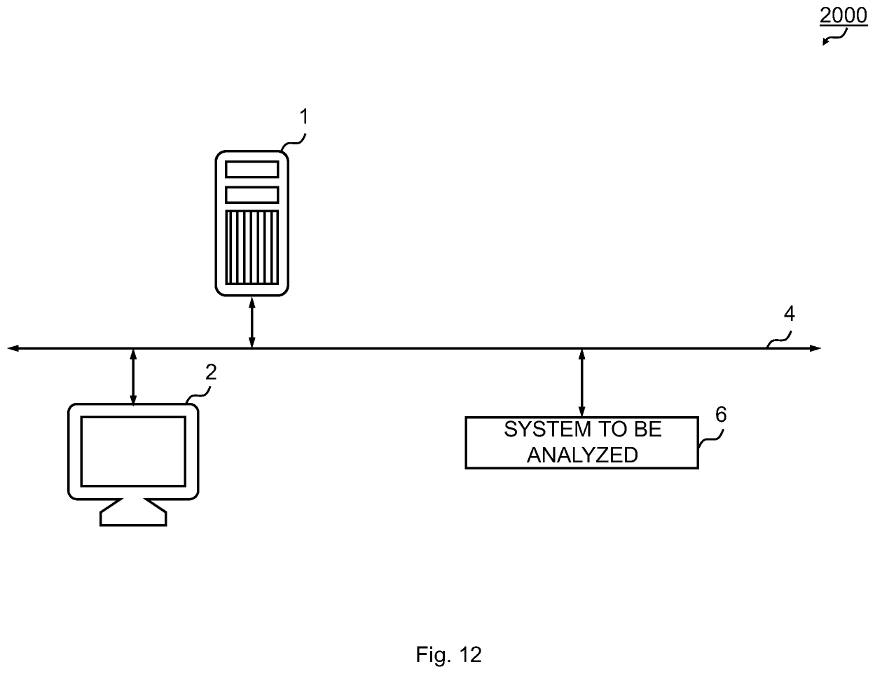

Next, with reference to FIG. 11, an operation is described as the system to be analyzed in a project management system 3B for providing a project progress management service instead of the authentication system 3A according to a modification of the present example embodiment. FIG. 11 is a diagram illustrating the data route for exchange in the project management system 3B. It is noted that it is described assuming that the progress management is performed for the project relating the user corresponding to the user information 350 in an example shown in FIG. 11. Also, it is assumed that the image transforming processing 351 for generating a thumbnail image based on the user information 350 and a task management processing 352 are performed according to the scenario 141C (see FIG. 4), and the analysis server 1 communicates with the project management system 3B and obtains the historical information in an example shown in FIG. 12.

It is noted that the project management system 3B includes a project management server 35 and a project management DB (Data Base) 36. Also, it is assumed that the project management server 35 and the project management DB 36 are connected to the analysis server 1 respectively over the network 4. Further, each of the project management server 35 and the project management DB 36 corresponds to the host terminal included in the project management system 3B.

According to the modification of the present example embodiment, it is assumed that, for example, the information is transmitted for designating the operation in which “the project management system 3B manages the project progress related to the user” from the user terminal 2 to the analysis server 1 as the information on designating the result of the processing that can be performed in the system to be analyzed. In this case, the scenario selection controlling unit 140 may generate and store on the scenario storing unit 141, the scenario 141C in which “the processing for receiving the user information”, “the processing for displaying the thumbnail image from the received user information”, and “the processing for performing the task management identified by the user information on the user” are described in order.

Upon receiving the user information 350, the project management server 35 starts the image transforming processing 351 and the task management processing 352. In the image transforming processing 351, the processing is performed for transforming to the thumbnail image the image “FFFF.jpg” included in the user information 350.

The analysis server 1 receives as the historical information when the project management server 35 performs the image transforming processing 351, “read (user/xxx/files/2020/ . . . /FFFF jpg)”, . . . , “(sh) execve (transform) . . . ”, . . . , “rw(user/xxx/files/2020/ . . . /FFFF.thumb)” as shown in FIG. 12. Then, in the analysis server 1 as described in the section <2.4.>, the data flow information when the image transforming processing 351 is performed is generated, and the risk determining processing is performed for the generated data flow information.

Also, in the task management processing 352, an event information obtaining task 353, a notification setting task 354 and other tasks 355 are performed as a subtask. The event information obtaining task 353 is a task for obtaining from the project management DB 36, a variety type of event information such as conference and deadline for the project related to the user corresponding to the user information 350. Also, the notification setting task 354 is a task for setting the notification of the information on the project managed by the task management processing 352 to the terminal of the user corresponding to the user information 350.

Each of the event information obtaining task 353, the notification setting task 354 and the other task 355 is a task performed by accessing the information resource different from the image transforming processing 351 in the project management server 35. Therefore, the analysis server 1, as described in the section <2.4.>, generates the data flow information when performing the task management processing 352, and performs the risk determining processing for the generated data flow information. It is noted that the determination result of the risk determining processing related to the task management processing 352 may be displayed on the GUI 300 for each of the event information obtaining task 353, the notification setting task 354 and the other task 355.

### 4. Second Example Embodiment

According to the first example embodiment, the example embodiment is described of determining whether to involve the security risk based on the historical information such as system call and snapshot obtained from the system to be analyzed. It is possible to analogize, related to the data route in the system to be analyzed, function for the data route such as firewall and protected communication, logical structure of the data route, and geographical relation of the data route, by using a wide variety of information disclosed in the internet in addition to the historical information such as system call and snapshot.

For example, in recent years for data protection, a backup is commonly provided in the remote server as the means for backup of the data to be protected. It is common to perform the transmission of the data to be protected to the remote server as the batch processing. In this case, it can be determined whether the server for backup is provided remotely by obtaining the IP address allocation information disclosed in the internet.

According to the present example embodiment, an example aspect is described of determining whether to involve the security risk with enriching the data flow in the system to be analyzed by adding to the historical information, the information on analogizing the functional logical structure for the data route and the geographical relation of the data route, and. It is noted that the identical element according to the second example embodiment to that according to the first example embodiment may denoted by the identical reference number, and overlapping description may omitted.

### 4.1. Operational Style of Analysis System

With reference to FIG. 12, an operational style of an analysis system 2000 is described according to the second example embodiment. FIG. 12 is a diagram illustrating the operational style of the analysis system. As shown in FIG. 12, the analysis system 2000 includes an analysis server 1, a user terminal 2 and a server to be analyzed 6 that are configured to be connected over the network 4.

The analysis server 1 determines whether to involve the security risk based on the information obtained from the server to be analyzed 6. The analysis server 1 according to the present example embodiment corresponds to an example of an analysis apparatus.

The user terminal 2 is an information processing terminal for the operator in the analysis system 2000 to operate the analysis server 1. The server to be analyzed 6 corresponds to a system for providing office solution with a server apparatus, cloud and on-site data center for example.

### 4.2. Overview of System to be Analyzed

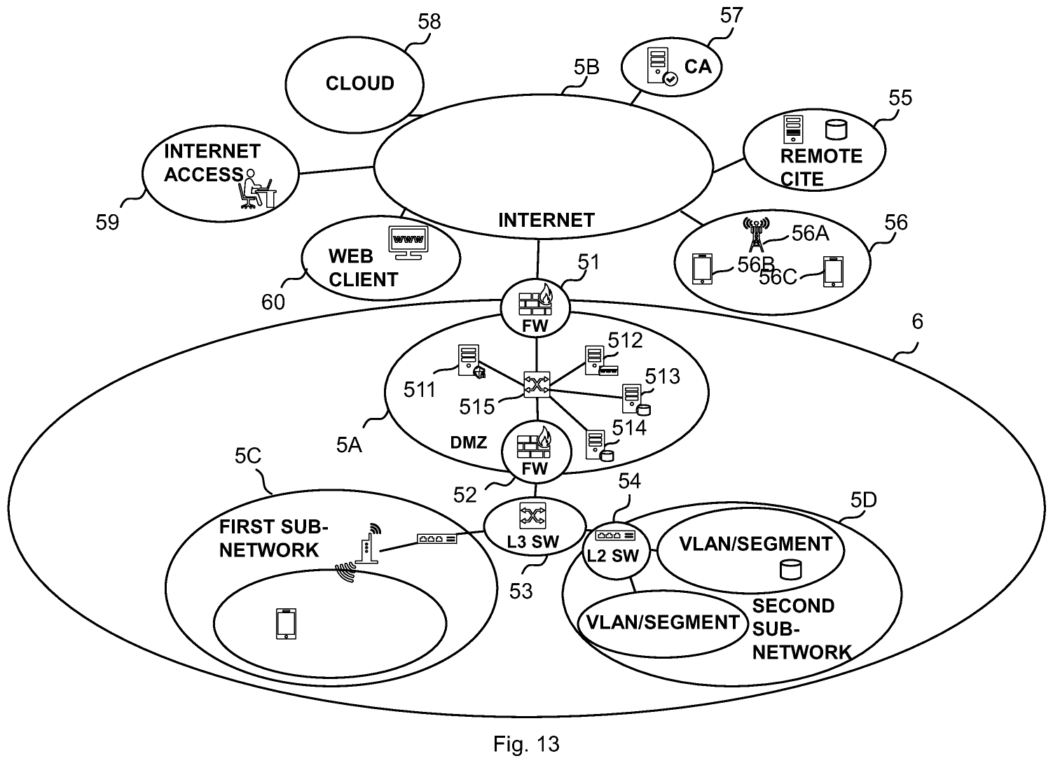

Next, with reference to FIG. 13, an overview of the server to be analyzed 6 is described. FIG. 13 is a diagram showing the overview of the system to be analyzed 6. As shown in FIG. 13, the server to be analyzed 6 is a system provided across a demilitarized zone 5A (hereinafter referred to as “DMZ”), a first sub-network 5C and a second sub-network 5D.

The DMZ 5A is an intermediate network separated from the internet 5B by the firewall (FW) 51. The host terminal in the DMZ 5A can access the internet 5B.

In the internet 5B, it is provided a remote site 55 such as a data center provided in a geographical remote area, a wireless communication system 56 for implementing the communication by a wireless base station from mobile terminals 56B and 56C to the internet 5B, a certificate authority 57 (hereinafter referred to as “CA”) for issuing a public key certificate used for encryption, and a cloud 58 for providing a computer resource over the internet 5B. The host terminal in the DMZ 5A accesses the remote site 55, the certificate authority 57, the cloud 58 and so on over the internet 5B. Also, the host terminal in the DMZ 5A can obtain the data exchanged in the wireless communication system 56 over the internet 5B.

Also, an internet access 59 is a network technology service such as VPN (Virtual Private Network), and implements secure connection to the internet 5B from a client terminal owned by an individual. Also, a WEB client 60 is a service for connecting to the internet 5B from a WEB browser installed in the client terminal owned by the individual, and allowing for accessing specific information resource over the internet 5B. A remote desktop WEB client is known as the WEB client 60 for example.

The DMZ 5A includes a host apparatus such as an anti-fraud server 511 that implements an Intrusion Detection System (IDS) for detecting hacking to the DMZ 5A and an Intrusion Prevention System (IPS) for preventing the hacking to the DMZ 5A, a Web server 512 for displaying a HTML and object to the WEB browser of the client terminal in the DMZ 5A, an FTP server 513 for transmitting and receiving a file, and a DNS server 514 for providing a Domain Name System (DNS). The anti-fraud server 511, the Web server 512, the FTP server 513 and the DNS server 514 are connected via a L3 switch 515.

The DMZ 5A according to the present example embodiment corresponds to a multi-stage firewall type DMZ in which the FW 51 is provided at a border between the internet 5B and the DMZ 5A, and the FW 52 is provided at a border between the DMZ 5A, the first sub-network 5C and the second sub-network 5D. In this way, it can implement the connection to the internet 5B with maintaining the security in the first sub-network 5C and the second sub-network 5D by placing in the DMZ 5A, the host terminal such as the server to be connected to the internet 5B.

The first sub-network 5C and the second sub-network 5D are connected to the DMZ 5A via the L3 switch 53. The first sub-network 5C corresponds to an in-house network for providing a wireless LAN. The second sub-network 5D corresponds an intra network in which the first sub-network 5C is provided, and has a plurality of VLANs and segments.

The FW 52 permits the access from the first sub-network 5C and the second sub-network 5D to the DMZ 5A while forbidding the access from the DMZ 5A to the first sub-network 5C and the second sub-network 5D. That is, it can access the DMZ 5A from the host terminal in the first sub-network 5C and the host terminal in the second sub-network 5D to the DMZ 5A, and cannot access from the host terminal in the DMZ 5A to the first sub-network 5C and the second sub-network 5D.

In this way, the server to be analyzed 6, if the host terminal in the DMZ 5A is attacked from the internet 5B, enables the host terminal in the DMZ 5A to provide the service to the internet 5B with protecting by the DMZ 5A the first sub-network 5C and the second sub-network 5D as internal network.

By the way, as mentioned above, the host terminal in the DMZ 5A access the remote site 55, the certificate authority 57 and the cloud 58 over the internet 5B. Also, the host terminal in the DMZ 5A obtains over the internet 5B the data exchanged in the wireless communication system 56.

Therefore, in order to comprehensively understanding the security risk involved in the data route for exchange by the host terminal in the DMZ 5A, it is necessary to obtain the system call when transmitting and receiving the data between the host terminal in the DMZ 5A, and the remote site 55, the certificate authority 57 and the cloud 58. Also, the information disclosed on the internet 5B and the data exchanged in the wireless communication system 56 cannot obtained by snapshotting the server to be analyzed 6.

Therefore, according to the present example embodiment, it is determined whether the data route involves the security risk by adding to the historical information as external information, the information on analogizing the functional logical structure for the data route and the geographical relation of the data route.

### 4.3. Functional Configuration of Analysis Server

Next, with reference to FIG. 14, a functional configuration of the analysis server 1 is described according to the second example embodiment. FIG. 14 is a functional block diagram showing the functional configuration of the analysis server 1 according to the present example embodiment. The identical element in FIG. 14 to the functional configuration of the analysis server 1 according to the first example embodiment may denoted by the identical reference number, and overlapping description may omitted.

As shown in FIG. 14, the controller 100 of the analysis server 1 includes a received information DB 150, a data flow generating unit 170, a risk determining unit 180, a condition DB 181, a historical information collecting unit 220, and an information adding unit 230. It is noted that in addition to the element shown in FIG. 14, the controller 100 may include the element described in FIG. 4 (e.g., the main controlling unit 110, the transmitting and receiving unit 120, the scenario storing unit 141, the scenario performance controlling unit 160, the UI controlling unit 190, and the access right obtaining unit 210).

The received information DB 150 is a storage area for storing the information collected by the agents 131D, 131E and 131F, and the information received from the server to be analyzed 6.

The data flow generating unit 170 performs a data flow graph generating processing for generating based on the historical information collected by the historical information collecting unit 220, the data flow graph that indicates the data route for exchange in the server to be analyzed 6.

The risk determining unit 180 performs a risk determining processing for determining based on the determining condition stored on the condition DB 181, whether to involve in the server to be analyzed 6. The detailed procedure of the risk determining processing is described below.

The historical information collecting unit 220 installs the agents 131D, 131E and 131F stored on the agent storing unit 131 for the host terminal included in the server to be analyzed 6, and collects as the historical information, the operational history for the program executed in the host terminal. Each of the agents 131D, 131E and 131F is installed on different host terminal, and transmits to the analysis server 1 as the historical information, the system call for the host terminal on which it is installed. It is noted that the historical information collecting unit 220 may collect as the historical information, the information obtained by snapshotting the server to be analyzed 6.

The information adding unit 230 obtains the external information from the information resource other than the host terminal that collection source for the historical information, and adds the external information to the historical information. The external information according to the present example embodiment corresponds to the information obtained from the internet 5B, the first sub-network 5C and the second sub-network 5D when the agents 131D, 131E and 131F are installed on the host terminal in the DMZ 5A (see FIG. 13) for example, and the information obtained from the host terminal on which the agents 131D, 131E and 131F are not installed, the L3 switch 53 and router.

That is, when the operational history for the program executed by the DNS server 514 in the DMZ 5A is collected as the historical information, the public data base disclosed on the internet 5B, Active Directory (registered trademark) implemented in the cloud 58, the host terminal in the remote site 55, the wireless communication system 56, the first sub-network 5C and the second sub-network 5D, the host terminal in the DMZ 5A on which the agents 131D, 131E and 131F are not installed, and the L3 switch 53 and the router correspond to the information resources other than the information processing apparatus that executes the program for which the historical information is to be collected. Then, the data to be transmitted from these information resources to the analysis server 1 is an example of the external information.

It is noted that when the agents 131D, 131E and 131F perform the collecting processing according to the scenario 141 (see FIG. 4), the information adding unit 230 may obtain as the external information, the information not defined in the scenario 141, and add the obtained external information to the historical information.

According to the above-described configuration, the analysis server 1 according to the present example embodiment adds the external information to the historical information obtained from the system to be analyzed, and analyzes whether the system to be analyzed involves the security risk.

### 4.4. Overview of Processing in Analysis System

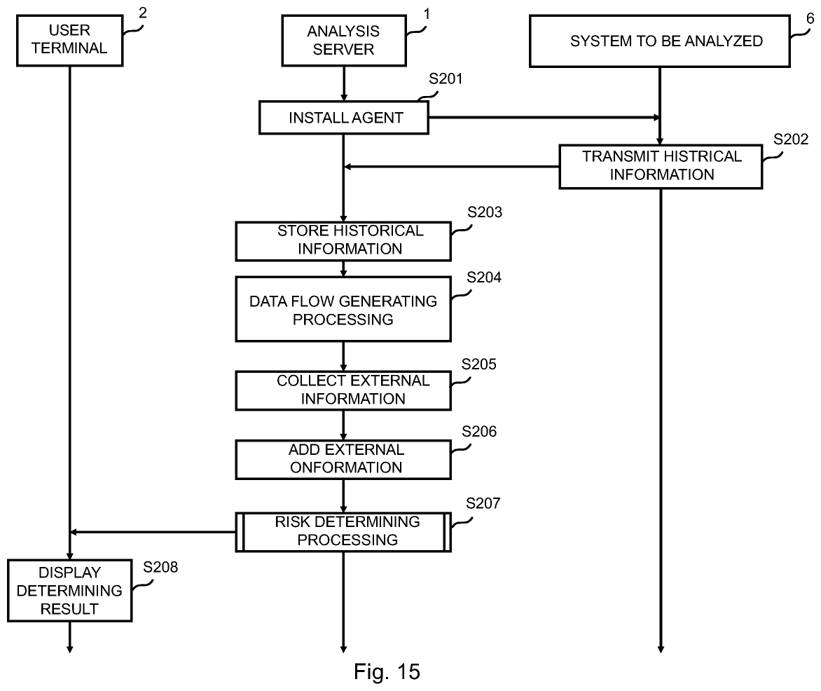

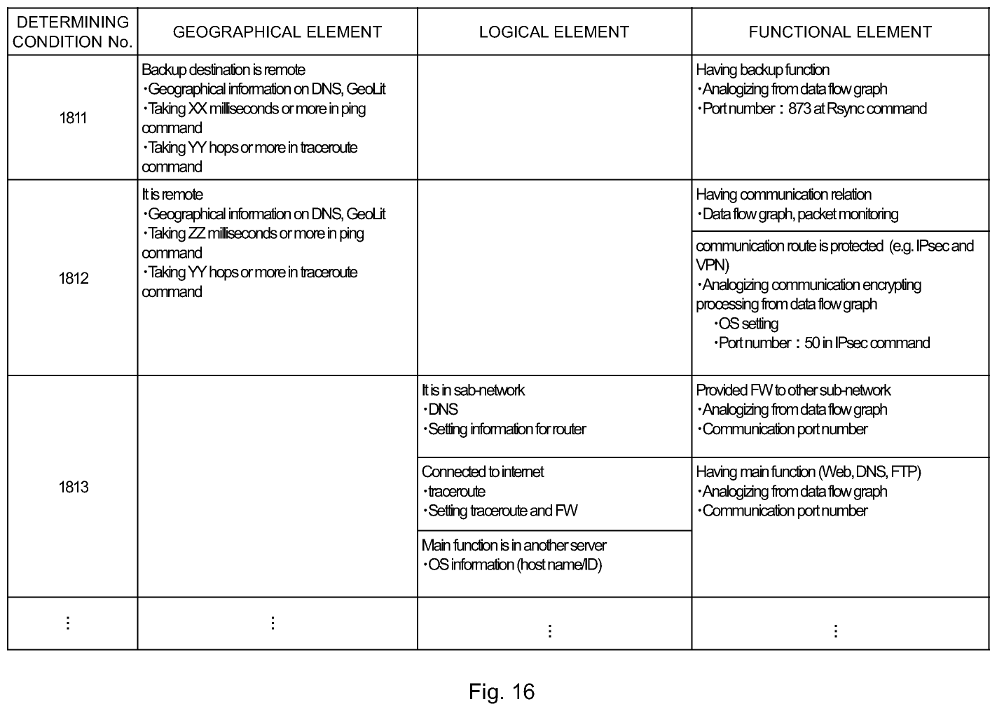

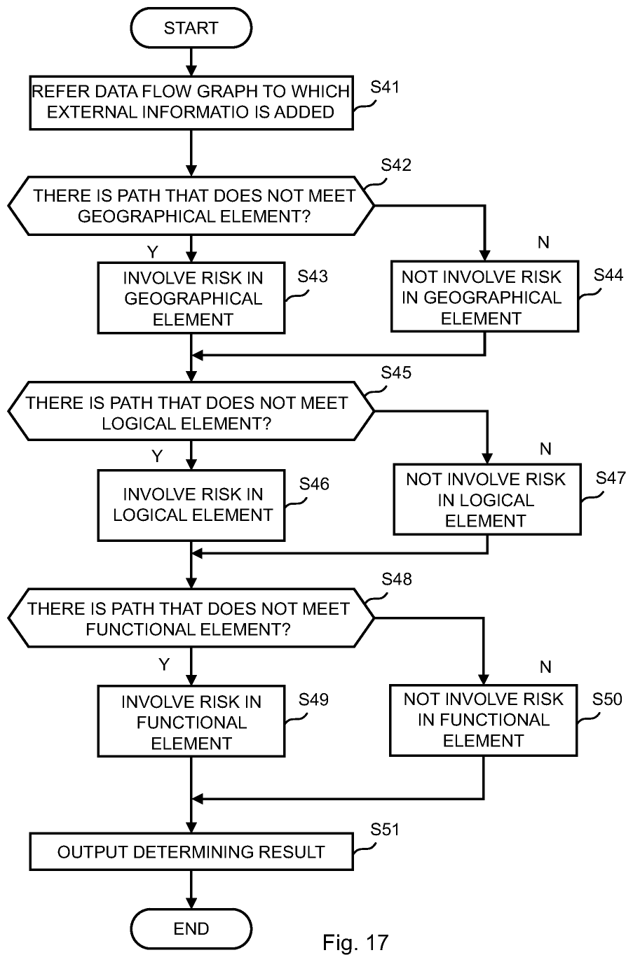

Next, with reference to FIG. 15 to FIG. 17, an overview of a processing in the analysis system 2000 is described according to the present example embodiment. FIG. 15 is a sequence diagram showing a flow in the processing in the analysis system 2000. FIG. 16 is a diagram describing a detail of the determining condition stored on the condition DB 181. FIG. 17 is a flowchart showing a flow in the risk determining processing.

### 4.4.1. Flow in Processing in Analysis System

Firstly, with reference to FIG. 15, the flow in the processing in the analysis system 2000 is described. In FIG. 15, the operator in the analysis system 2000 performs for the user terminal 2, the operation for starting the security risk analysis in the analysis system 2000. It is assumed that the operation for starting the security risk analysis is performed in the user terminal 2 by designating the server to be analyzed 6 as an object to be analyzed.

In step S201, the historical information collecting unit 220 installs on the host terminal included in the server to be analyzed 6, the agents 131D, 131E and 131F that perform the collecting processing for collecting the historical information. The description proceeds assuming that the historical information collecting unit 220 installs the agent 131D on the Webserver 512 that is the host terminal included in the DMZ 5A, installs the agent 131E on the FTP server 513, and installs the agent 131F on the DNS server 514, respectively. In the following description, “the host terminal in the DMZ 5A”, and the agents 131D, 131E and 131F may be referred to as “agent” if it is not necessary to distinguish the Web server 512, the FTP server 513 and the DNS server 514.

In the host terminal in the DMZ 5A on which the agent is installed, the agent performs the collecting processing for the historical information. The agent obtains as the historical information, the information relating to the communication probing such as ping and traceroute in the host terminal on which it is installed, the information on the packet monitoring in the host terminal, and the information on the OS and application in the host terminal. The historical information can be obtained by the system call in the host terminal in the DMZ 5A and by the snapshot of the host terminal in the DMZ 5A. It is noted that the operator in the analysis server 1 may operate the user terminal 2 to select the scenario for causing the server to be analyzed 6 to perform. In step S202, the host terminal in the DMZ 5A transmits to the analysis server 1, the historical information collected by the agent, and terminates the collecting processing.

The historical information transmitted from the host terminal in the DMZ 5A to the analysis server 1 is stored on the received information DB 150 in step S203. It is noted that the analysis server 1 may obtain based on the historical information, the access right information on the file that is accessed by the program executed in the server to be analyzed 6, and store on the received information DB 150.

Next, in step S204, the data flow generating unit 170 performs a data flow generating processing based on the information stored on the received information DB 150. In the data flow generating processing, the data flow graph generated by the data flow generating unit 170 corresponds to the information in which the data route for exchange by the system to be analyzed is represented in the set of the node and the edge (see FIG. 8), the node includes information body such as file, and the edge connects two different nodes.

It is noted that the data flow generating unit 170 may generate the data flow graph to include the access right information corresponding to the file identifier included in the historical information. Besides, the data flow generating unit 170 may generate the data flow graph to include the information on assigning the access right information on the data file corresponding to the file identifier included in the historical information. Also, the data flow generating unit 170 may perform the extracting processing for extracting a predetermined path from the data flow graph.

In this way, the information corresponding to the data route (data flow graph) is generated based on the operational history for the program when actually executing the program in the server to be analyzed 6 according to the present example embodiment.

Next, in step S205, the information adding unit 230 obtains from the server to be analyzed 6, the external information on adding to the data flow graph. As mentioned above, the information adding unit 230 obtains the external information from the information resource other than the host terminal that collection source for the historical information. The external information obtained as the external information by the information adding unit 230 includes for example the followings:
Information disclosed on the internet 5B (including the geographical information indicating the geographical element for the data route such as domain name and sub-network name, and the functional information on identifying the functional element for the data route such as version information of application and security patch)
Geographical information indicating the geographical element for the data route such as country and region name identified from the IP address that is provided via the Web service on the internet 5B
Logical information on identifying the logical element and the functional information on identifying the functional element for the vertical machine and container in the container management service that is provided on the internet 5B
Functional information on identifying the functional element for the data route such as the data for setting the router and switch that are included in the server to be analyzed 6
Functional information on identifying the functional element for the data route such as the data for packet monitoring in the mirror port of the router included in the server to be analyzed 6
Functional information on identifying the functional element for the data route such as in-house communication information in which the IP address stored on the host terminal in the first sub-network 5C and second sub-network and the department identifier are linked

The information adding unit 230, in step S206, adds to the data flow graph, the external information obtained from the server to be analyzed 6. In this way, the historical information represented as the data flow graph is enriched with the information on the server located offsite and the information on allowing to analogize the function and logical structure of the data route.

Next, in step S207, the risk determining unit 180 performs the risk determining processing based on the data flow graph to which the external information is added, and transmits the determination result to the user terminal 2. In the risk determining processing, it is determined whether the data route indicated in the data flow information involves the security risk based on the determining condition stored on the condition DB 181. The risk determining processing is described in detail below.

Upon receiving the determination result of the risk determining processing, in step S208, the user terminal 2 displays the determination result of the risk determining processing. According to the present example embodiment, the screen including the determination result of the risk determining processing is displayed on the user terminal 2 for example. The operator in the analysis system 2000 can confirm from the determination result of the risk determining processing that is displayed on the user terminal 2, whether the data route for exchange by the analysis system 2000 involves the security risk.

### 4.4.2. Flow in Risk determining Processing in Analysis Server

Next, with reference to FIG. 16 and FIG. 17, a flow in the risk determining processing is described according to the present example embodiment. This processing corresponds to the processing performed in step S207 shown in FIG. 15.

FIG. 16 is a diagram showing an example of the determining condition stored on the condition DB 181. As shown in FIG. 16, the determining conditions 1811, 1812 and 1813 stored on the condition DB 181 include at least any one element of the geographical element for the data route, the logical element indicating the logical structure for the data route, and the functional element for the function of the data route.

For example, the determining condition 1811 is a condition for determining whether “the information that should not be missed is designed to be backup remotely”. The determining condition 1811 includes the geographical element and the functional element.

The determining condition 1811 includes as the geographical element, the condition for determining whether the backup destination is remote. Also, the determining condition 1811 includes as the functional element, the condition for determining whether to have the backup function.

The risk determining unit 180 can determine from the geographical element included in the determining condition 1811, whether the backup destination is remote in the data route indicated in the data flow graph based on the condition “geographical information on DNS, GeoLite”, “taking XX milliseconds or more in ping command” and “taking YY hops or more in traceroute command”. It is noted that GeoLite refers to the service provided from MaxMind (registered trademark) for estimating the region from the IP address. In addition to GeoLite, the service provided on the internet 5B may be used as the service for estimating the region from the IP address. Also, the risk determining unit 180 can determine from the functional element included in the determining condition 1811, whether to have the backup function in the data route indicated in the data flow graph based on the conditions “analogizing from data flow graph” and “port number: 873 at Rsync command”.

Also, for example, the determining condition 1812 is a condition for determining whether “the communication route is designed to be protected if it is necessary to connect to the remote system and device”. The determining condition 1812 includes as the geographical element, the condition for determining whether it is remote. Also, the determining condition 1812 includes as the functional element, the condition for determining whether to have the communication relation and the condition for determining whether the communication route is protected via the IPsec and VPN.

The risk determining unit 180 can determine from the geographical element included in the determining condition 1811, whether the data route indicated in the data flow graph is remote based on the condition “geographical information on DNS, GeoLite”, “taking ZZ milliseconds or more in ping command” and “taking YY hops or more in traceroute command”. Also, the risk determining unit 180 can determine from the functional element included in the determining condition 1812, whether to have the communication relation based on the conditions “data flow graph and packet monitoring”. Further, the risk determining unit 180 can determine from the functional element included in the determining condition 1812, whether the communication route is protected in the data route indicated in the data flow graph via the IPsec and VPN based on the conditions “analogizing communication encrypting processing from data flow graph”, “OS setting”, and “port number: 50 in IPsec command”.

Also, for example, the determining condition 1813 is a condition for determining whether “the server installed in the DMZ” is prepared for each main function. The determining condition 1813 includes as the logical element, the condition for determining whether it is the sub-network, the condition for determining whether it is connected to the internet, and the condition for determining whether the main function is in another server. Also, the determining condition 1813 includes as the functional element, the condition for determining whether to provide the firewall (FW) to the other sub-network, and the condition for determining whether to have the main function such as Web, DNS and FTP.

The risk determining unit 180 can determine from the logical element included in the determining condition 1813, whether the data route indicated in the data flow graph is in the sub-network based on the conditions “DNS” and “setting information on router”. Also, the risk determining unit 180 can determine from the logical element included in the determining condition 1813, whether the data route indicated in the data flow graph is connected to the internet based on the conditions “traceroute” and “setting for router and FW”. Further, the risk determining unit 180 can determine from the logical element included in the determining condition 1813, whether the main function is in another server in the data route indicated in the data flow graph based on the condition “information on OS such as host name and ID”.

Also, the risk determining unit 180 can determine from the functional element included in the determining condition 1813, whether to provide the FW to the other sub-network in the data route indicated in the data flow graph, based on the conditions “analogizing from data flow graph” and “communication port number”. Further, the risk determining unit 180 can determine from the functional element included in the determining condition 1813, whether to have the main function such as Web, DNS and FTP in the data route indicated in the data flow graph, based on the conditions “analogizing from data flow graph” and “communication port number”.

It is noted that the determining conditions 1811, 1812 and 1813 are stored on the condition DB 181 as the algorithm in which the conditions shown in FIG. 16 are described as parameter. Each of the determining conditions 1811, 1812 and 1813 illustrated in FIG. 16 is only an example of the determining condition stored on the condition DB 181. As long as at least any one element of the geographical element for the data route, the logical element indicating the logical structure for the data route and the functional element for the function of the data route is included, the at least one can be used as the determining condition in the risk determining processing.

Also, the determining condition stored on the condition DB 181 may be constructed by the operator in the analysis system 2000. In this case, the operator in the analysis system 2000 can determine the security risk in the data route for exchange by the server to be analyzed 6 by constructing the determining condition to include at least any one of the geographical element, the logical element, and the functional element.

In this way, the risk determining unit 180 performs based on the determining condition stored on the condition DB 181, the risk determining processing for the data flow graph to which the external information is added. Next, with reference to FIG. 17, the flow in the risk determining processing is described.

It is illustrated and described as the data flow graph referred by the risk determining unit 180 from the received information DB 150, “the first graph that indicates the setting information on the FTP server 513 is stored as the backup on the host terminal located in the remote site 55 at a distance equal to or more than 2000 kilometers”.

It is described as an example, as the data flow graph referred by the risk determining unit 180 from the received information DB 150, “the second graph that indicates as the information on the server provided in the DMZ 5A, connection to the internet 5B is identified with traceroute command, the FW 51 is provided to the internet 5B, the FW 52 is provided to the L3 switch 53, and there are the anti-fraud server 511, the Web server 512, the FTP server 513 and the server 514 in the DMZ 5A”. Also, it is assumed that the risk determining unit 180 performs the risk determining processing by applying the determining condition 1811 to the first graph and applying the determining condition 1813 to the second graph.

In step S41, the risk determining unit 180 refers from the received information DB 150, the data flow graph to which the external information is added. Then, in step S42, the risk determining unit 180 determines whether the data flow graph referred in step S41 includes the path that does not meet the geographical element of the determining condition stored on the condition DB 181. It is noted that if the determining condition does not include the geographical element, step S42 may be omitted.

If the data flow graph referred in step S41 includes the path that does not meet the geographical element of the determining condition stored on the condition DB 181 (step S42/Y), the risk determining unit 180, in step S43, determines that the data flow graph referred in step S41 involves the risk in the geographical element. Then, the risk determining unit 180 proceeds to step S45.

If the data flow graph referred in step S41 does not include the path that does not meet the geographical element of the determining condition stored on the condition DB 181 (step S42/N), the risk determining unit 180, in step S44, determines that the data flow graph referred in step S41 does not involve the risk in the geographical element. Then, the risk determining unit 180 proceeds to step S45.

For example, the first graph is the data flow graph indicating that “the backup is stored on the host terminal located in the remote site 55 at a distance equal to or more than 2000 kilometers”. However, the first graph does not include the path indicating that “taking XX milliseconds or more in ping command” and “taking YY hops or more in traceroute command” at the remote site 55. In this case, the risk determining unit 180 determines that the first graph involves the risk in the geographical element included in the determining condition 1811 (step S43), and proceeds to step S45.

In step S45, the risk determining unit 180 determines whether the data flow graph referred in step S41 includes the path that does not meet the logical element of the determining condition stored on the condition DB 181. It is noted that if the determining condition does not include the logical element, step S45 may be omitted.

If the data flow graph referred in step S41 includes the path that does not meet the logical element of the determining condition stored on the condition DB 181 (step S45/Y), the risk determining unit 180, in step S46, determines that the data flow graph referred in step S41 involves the risk in the logical element. Then, the risk determining unit 180 proceeds to step S48.

If the data flow graph referred in step S41 does not include the path that does not meet the logical element of the determining condition stored on the condition DB 181 (step S45/N), the risk determining unit 180, in step S47, determines that the data flow graph referred in step S41 does not involve the risk in the logical element. Then, the risk determining unit 180 proceeds to step S48.

For example, the second graph includes the information “indicating as the information on the server provided in the DMZ 5A, the FW 51 is provided to the internet 5B, the FW 52 is provided to the L3 switch 53, and there are the anti-fraud server 511, the Web server 512, the FTP server 513 and the server 514 in the DMZ 5A”. That is, the second graph is the path that meets as the logical element included in the determining condition 1813, the condition for determining whether it is the sub-network, the condition for determining whether it is connected to the internet, and the condition for determining whether the main function is in another server. In this case, the risk determining unit 180 determines that the second graph does not involve the risk in the logical element included in the determining condition 1813 (step S47), and proceeds to step S48.

In step S48, the risk determining unit 180 determines whether the data flow graph referred in step S41 includes the path that not meet the functional element of the determining condition stored on the condition DB 181. It is noted that if the determining condition does not include the functional element, step S48 may be omitted.

If the data flow graph referred in step S41 includes the path that does not meet the functional element of the determining condition stored on the condition DB 181 (step S48/Y), the risk determining unit 180, in step S49, determines that the data flow graph referred in step S41 involves the risk in the logical element. Then, the risk determining unit 180 proceeds to step S51.

If the data flow graph referred in step S41 does not includes the path that does not meet the functional element of the determining condition stored on the condition DB 181 (step S48/N), the risk determining unit 180, in step S50, determines that the data flow graph referred in step S41 does not involve the risk in the functional element. Then, the risk determining unit 180 proceeds to step S51.

For example, the first graph is the data flow graph “indicating that the backup is stored on the host terminal located in the remote site 55 at a distance equal to or more than 2000 kilometers”. Therefore, the first graph is the path that indicates to have the backup function when “analogizing from the data flow graph”. On the other hand, the first graph is the path that does not meet the condition of “port number: 873 at Rsync command” of the functional element included in the determining condition 1811. That is, since the first graph includes the path that does not meet the functional element of the determining condition 1811, the risk determining unit 180 determines that the first graph involves the risk in the functional element of the determining condition 1811 (step S49), and proceeds to step S51.

Also, for example, the second graph is the data flow graph that includes the information “indicating as the information on the server provided in the DMZ 5A, the FW 51 is provided to the internet 5B, the FW 52 is provided to the L3 switch 53, and there are the anti-fraud server 511, the Web server 512, the FTP server 513 and the server 514 in the DMZ 5A”. That is, the second graph is the path that meets as the functional element included in the determining condition 1813, the condition for determining whether the firewall (FW) is provided to the other sub-network and the condition for determining whether there is the main function such as Web, DNS and FTP. In this case, the risk determining unit 180 determines that the second graph does not include the path that does not meet the functional element of the determining condition 1813 (step S50), and proceeds to step S51.

Then, in step S51, the risk determining unit 180 outputs for the user terminal 2, the result of the risk determining processing. For example, the determination result is output indicating that the data route indicated in the second graph does not involve the security risk. Also, for example, the determination result is output indicating that the data route indicated in the first graph involves the risk in the geographical element and the functional element.

As described above, according to the present example embodiment, it is determined whether to involve the security risk by enriching the historical information represented as the data flow graph, with the information on the server located off-site and the information on allowing to analogize the function and the logical structure of the data route. In this way, it can be determined to involve the security risk by comprehensively understanding the data route for exchange by the system to be analyzed.

Also, according to the present example embodiment, the determining condition used in the risk determining processing includes at least one of the geographical element for the data route, the logical element indicating the logical structure for the data route, and the functional element for the function of the data route. According to the present example embodiment, by using the element of the determining condition, it makes easier for the operator in the analysis system 2000 to know which element in the data route involves the security risk by classifying into the geographical element, the logical element and the functional element for the data route and performing the risk determining processing,

### 5. Third Example Embodiment

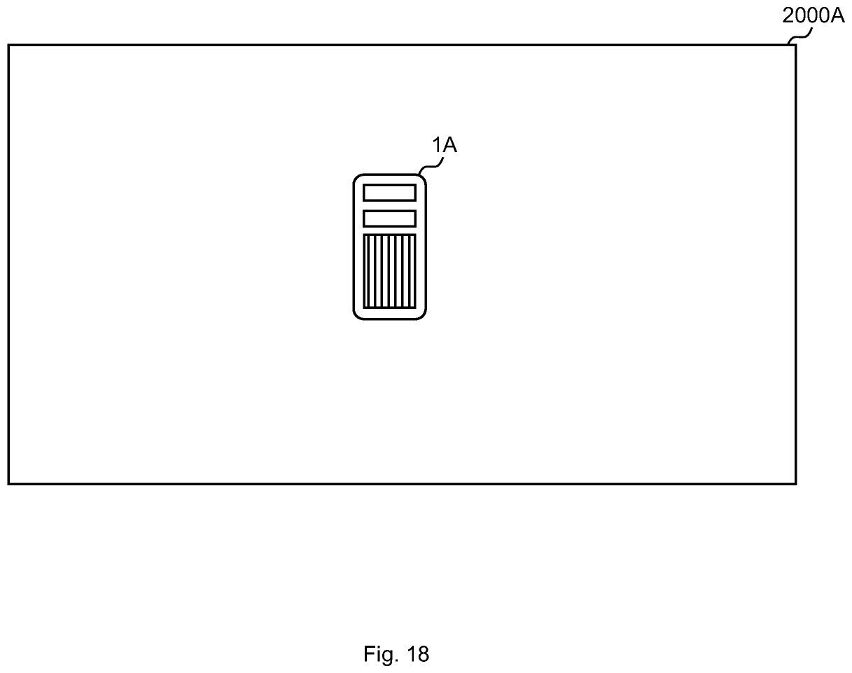

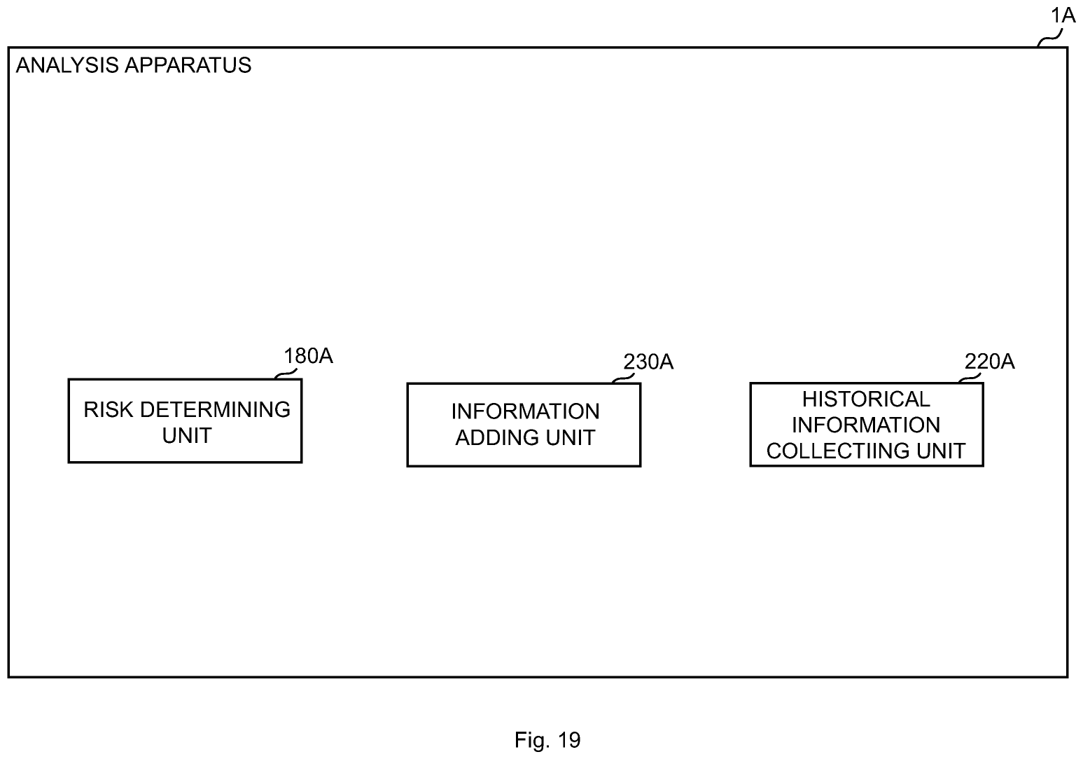

Next, with reference to FIG. 18 and FIG. 19, a third example embodiment is described according to the present invention. The above-mentioned second example embodiment is a specific example embodiment, whereas the third example embodiment is a more generalized example embodiment. According to the following third example embodiment, similar effect is provided to the second example embodiment.

FIG. 18 is a diagram illustrating a schematic configuration of an analysis system 2000A according to the third example embodiment. As shown in FIG. 18, the analysis system 2000A includes an analysis apparatus 1A.

FIG. 19 is a block diagram illustrating a schematic configuration of the analysis apparatus 1A according to the third example embodiment. As shown in FIG. 19, the analysis apparatus 1A includes a historical information collecting unit 220A, an information adding unit 230A and a risk determining unit 180A.

The historical information collecting unit 220A collects the historical information on the operational history for the program executed in the system to be analyzed. The information adding unit 230A adds to the historical information, the external information obtained from the information resource other than the information processing apparatus that executes the program. The risk determining unit 180A performs the risk determining processing for determining based on the preset determining condition, whether to involve the security risk in the historical information to which the external information is added.

Relation with Second Example Embodiment

As an example, the analysis apparatus 1A according to the third example embodiment may perform the operation of the analysis server 1 according to the second example embodiment. Similarly, as an example, the analysis system 2000A according to the third example embodiment may be configured in a similar way to the analysis system 2000 according to the second example embodiment. In the case described above, description regarding the second example embodiment can also be applied to the third example embodiment. Note that the third example embodiment is not limited to the example described above.

### 6. Other Example Embodiments

Although the example embodiments have been described according to the present invention, the present invention is not limited to these example embodiments. It should be understood by one skilled in the art that these example embodiments are merely examples and that various alterations are possible without departing from the scope and the spirit of the present invention.

For example, the steps in the processing described in the Specification may not necessarily be performed in time series in the order described in the corresponding sequence diagram. For example, the steps in the processing may be performed in an order different from that described in the corresponding sequence diagram or may be performed in parallel. Some of the steps in the processing may be deleted, or more steps may be added to the processing.

Also, an apparatus including components of the analysis server 1 (e.g., element corresponding to each unit included in the controller 100) may be provided. Also, a method including a processing performed by the component may be provided, and a program causing a processor to perform the processing of the component may be provided. Further, a non-transitory computer readable medium storing the program may be provided. As a matter of course, such apparatus, module, method, program and non-transitory computer readable medium are included in the present invention.

The whole or part of the example embodiments disclosed above can be described as, but not limited to, the following supplementary notes.

### Supplementary Note 1

An analysis apparatus comprising:
a historical information collecting unit configured to collect historical information on an operational history for a program executed in a system to be analyzed;
an information adding unit configured to add to the historical information, external information obtained from an information resource other than an information processing apparatus that executes the program; and
a risk determining unit configured to perform a risk determining processing for determining based on preset determining condition, whether to involve security risk in the historical information to which the external information is added.

### Supplementary Note 2

The analysis apparatus according to supplementary note 1, wherein the determining condition includes at least any one of a geographical element for a data route, a logical element indicating a logical structure for the route, and a functional element for a function of the route.

### Supplementary Note 3

The analysis apparatus according to supplementary note 2, wherein
the external information includes at least any one of geographical information indicating the geographical element, logical information indicating the logical element, and functional information indicating the functional element.

### Supplementary Note 4

The analysis apparatus according to supplementary note 2 or 3, wherein
the risk determining unit performs the risk determining processing by classifying into the geographical element, the logical element and the functional element, the historical information to which the external information is added.

### Supplementary Note 5

The analysis apparatus according to any one of supplementary notes 1 to 4, wherein
the external information includes information disclosed on internet.

### Supplementary Note 6

The analysis apparatus according to any one of supplementary notes 1 to 4, wherein
the external information includes information stored on the information resource included in an inner network that is accessible to an intermediate network separated from internet by a firewall and that is not accessible from the intermediate network.

### Supplementary Note 7

The analysis apparatus according to any one of supplementary notes 1 to 6, wherein
the historical information is a data flow graph indicating a data route for exchange by the system to be analyzed.

### Supplementary Note 8

The analysis apparatus according to any one of supplementary notes 1 to 7, wherein
the historical information is information on system call invoked by the program.

### Supplementary Note 9

The analysis apparatus according to any one of supplementary notes 1 to 8, wherein
the historical information is information obtained by snapshotting the system to be analyzed during execution of the program.

### Supplementary Note 10

An analysis system comprising the analysis apparatus according to any one of supplementary notes 1 to 9.

### Supplementary Note 11

An analysis method comprising:
collecting historical information on an operational history for a program executed in a system to be analyzed;
adding to the historical information, external information obtained from an information resource other than an information processing apparatus that executes the program; and
performing a risk determining processing for determining based on preset determining condition, whether to involve security risk in the historical information to which the external information is added.

### Supplementary Note 12

An analysis program causing a processor to:
collect historical information on an operational history for a program executed in a system to be analyzed;
add to the historical information, external information obtained from an information resource other than an information processing apparatus that executes the program; and
perform a risk determining processing for determining based on preset determining condition, whether to involve security risk in the historical information to which the external information is added.

### INDUSTRIAL APPLICABILITY

It can be determined whether to involve the security risk based on the data flow in the system to be analyzed.

### REFERENCE SIGNS LIST

1 Analysis Server
1A Analysis Apparatus
2 User Terminal
4 Network
5 Operator
5A DMZ
5B Internet
5C First Sub-Network
5D Second Sub-Network
6 System to be analyzed
100 Controller
131D, 131E, 131F Agent
141 Scenario Storing Unit
150 Received information DB
170 Data Flow Generating Unit
180, 180A Risk Determining Unit
181 Condition DB
220, 220A Historical Information Collecting Unit
230, 230A Information Adding Unit
2000, 2000A Analysis System

What is claimed is:

1. An analysis apparatus comprising:
a memory storing instructions; and
one or more processors configured to execute the instructions to:
collect historical information on an operational history for a program executed in a system to be analyzed;
add to the historical information, external information obtained from an information resource other than an information processing apparatus that executes the program; and
perform a risk determining processing for determining based on preset determining condition, whether to involve security risk in the historical information to which the external information is added.

2. The analysis apparatus according to claim 1, wherein
the determining condition includes at least any one of a geographical element for a data route, a logical element indicating a logical structure for the route, and a functional element for a function of the route.

3. The analysis apparatus according to claim 2, wherein
the external information includes at least any one of geographical information indicating the geographical element, logical information indicating the logical element, and functional information indicating the functional element.

4. The analysis apparatus according to claim 2, wherein
the one or more processors are configured to execute the instructions to perform the risk determining processing by classifying into the geographical element, the logical element and the functional element, the historical information to which the external information is added.

5. The analysis apparatus according to claim 1, wherein
the external information includes information disclosed on internet.

6. The analysis apparatus according to claim 1, wherein
the external information includes information stored on the information resource included in an inner network that is accessible to an intermediate network separated from internet by a firewall and that is not accessible from the intermediate network.

7. The analysis apparatus according to claim 1, wherein
the historical information is a data flow graph indicating a data route for exchange by the system to be analyzed.

8. The analysis apparatus according to claim 1, wherein
the historical information is information on system call invoked by the program.

9. The analysis apparatus according to claim 1, wherein
the historical information is information obtained by snapshotting the system to be analyzed during execution of the program.

10. An analysis system comprising the analysis apparatus according to claim 1.

11. An analysis method comprising:
collecting historical information on an operational history for a program executed in a system to be analyzed;
adding to the historical information, external information obtained from an information resource other than an information processing apparatus that executes the program; and
performing a risk determining processing for determining based on preset determining condition, whether to involve security risk in the historical information to which the external information is added.

12. A non-transitory computer readable recording medium storing a program causing a processor to:
collect historical information on an operational history for a program executed in a system to be analyzed;
add to the historical information, external information obtained from an information resource other than an information processing apparatus that executes the program; and
perform a risk determining processing for determining based on preset determining condition, whether to involve security risk in the historical information to which the external information is added.
